(19) United States
(12) Patent Application Publication
(10) Pub. No.: US 2025/0150762 A1
(43) Pub. Date: May 8, 2025

(54) TRANSDUCER DEVICES, CORE MODULES, AND ELECTRONIC DEVICES

(71) Applicant: SHENZHEN SHOKZ CO., LTD., Shenzhen (CN)

(72) Inventor: Junjiang FU, Shenzhen (CN)

(73) Assignee: SHENZHEN SHOKZ CO., LTD., Shenzhen (CN)

(21) Appl. No.: 19/014,153

(22) Filed: Jan. 8, 2025

Related U.S. Application Data
(63) Continuation of application No. PCT/CN2023/091134, filed on Apr. 27, 2023.

(51) Int. Cl. H04R 9/06; H01F 7/02; H01F 7/20; H04R 9/02; H04R 9/04

(52) U.S. Cl. CPC H04R 9/06; H01F 7/02; H01F 7/20; H04R 9/025; H04R 9/046

(57) ABSTRACT

The present disclosure relates to a transducer device, a core module, and an electronic device. The transducer device comprises a first coil and a magnet assembly, and at least one first vibration transmission plate connecting the first coil and the magnet assembly. The magnet assembly surrounds a periphery of the first coil, the magnet assembly and the first coil are spaced apart in a radial direction of the transducer device and at least partially overlap in an axial direction. In an operation state in which the transducer device is input with a first excitation signal, the first coil is energized and generates a first Ampere force in a magnetic field formed by the magnet assembly, and the first Ampere force causes the first coil to move relative to the magnet assembly without an iron core and a magnetic conductive plate, which is conducive to increasing sensitivity of the transducer device.

### CROSS-REFERENCE TO RELATED APPLICATIONS

This application is a continuation of International Application No. PCT/CN2023/091134, filed on Apr. 27, 2023, the entire contents of which are incorporated herein by reference.

### TECHNICAL FIELD

The present disclosure relates to the technical field of electronic devices, and in particular, to a transducer device, a core module, and an electronic device.

### BACKGROUND

With the increasing popularity of electronic devices, electronic devices have become essential tools for socializing and entertainment in daily life, and people's requirements for electronic devices are getting higher and higher. Electronic devices such as headphones have also been widely used in people's daily lives. When paired with smartphones, computers, and other devices, earphones deliver an immersive auditory experience.

### SUMMARY

Embodiments of the present disclosure provide a transducer device, comprising a first coil, a magnet assembly, and at least one first vibration transmission plate connecting the first coil and the magnet assembly. The magnet assembly surrounds a periphery of the first coil, the magnet assembly and the first coil are spaced apart in a radial direction of the transducer device and at least partially overlap with each other in an axial direction of the transducer device. In an operation state in which the transducer device is input with a first excitation signal, the first coil is energized and generates a first Ampere force in a magnetic field formed by the magnet assembly, and the first Ampere force causes the first coil to move relative to the magnet assembly.

In some implementations, an inner side of the first coil is not provided with any hard magnet.

In some embodiments, the transducer device includes a first magnetic conductive member, the first coil surrounds a periphery of the first magnetic conductive member, and the first magnetic conductive member and the magnet assembly at least partially overlap with each other in the axial direction of the transducer device.

In some embodiments, a ratio between a dimension of the first magnetic conductive member in the axial direction to a dimension of the first coil in the axial direction is greater than or equal to 1.

In some embodiments, the first magnetic conductive member has a hollow structure.

In some embodiments, a ratio between a dimension of the first magnetic conductive member in the radial direction to a dimension of the first coil in the radial direction is within a range of 0.5 to 1.5.

In some implementations, the first magnetic conductive member is configured to be fixed relative to the magnet assembly, and at least a portion of the first magnetic conductive member is spaced from the first coil in the radial direction.

In some embodiments, the first magnetic conductive member includes a first main body portion and a first extension portion connected to the first main body portion, the first coil surrounds a periphery of the first main body portion and is spaced from the first main body portion in the radial direction, and the first extension portion is connected to the magnet assembly and is spaced from the first coil in the axial direction.

In some embodiments, the at least one first vibration transmission plate includes an inner ring fixation portion and an outer ring fixation portion nested with each other, and a plurality of spoke portions connecting the inner ring fixation portion and the outer ring fixation portion, the outer ring fixation portion is connected to the magnet assembly, the transducer device includes a frame connected to the first coil, the inner ring fixation portion is connected to a center region of the frame, or the inner ring fixation portion is connected to an edge region of the frame.

In some embodiments, the first magnetic conductive member is configured to be fixed relative to the first coil, and an orthographic projection of the first magnetic conductive member on a reference plane perpendicular to the axial direction does not overlap with an orthographic projection of the magnet assembly on the reference plane.

In some embodiments, an orthographic projection of the first coil on a reference plane perpendicular to the radial direction, an orthographic projection of the magnet assembly on the reference plane perpendicular to the radial direction, and an orthographic projection of the first magnetic conductive member on the reference plane perpendicular to the radial direction at least partially overlap, and a distance between an overlapping region of the first magnetic conductive member and an overlapping region of the magnet assembly in the radial direction is less than or equal to 1.5 times a minimum distance between the first magnetic conductive member and the magnet assembly.

In some implementations, a distance between the first coil and the first magnetic conductive member in the radial direction is less than a distance between the first coil and the magnet assembly in the radial direction.

In some embodiments, the at least one first vibration transmission plate includes an inner ring fixation portion and an outer ring fixation portion nested with each other, and a plurality of spoke portions connecting the inner ring fixation portion and the outer ring fixation portion, and the outer ring fixation portion is connected to the magnet assembly, and the inner ring fixation portion is connected to the first magnetic conductive member.

In some embodiments, the at least one first vibration transmission plate includes an inner ring fixation portion and an outer ring fixation portion nested with each other, and a plurality of spokes connecting the inner ring fixation portion and the outer ring fixation portion, the outer ring fixation portion is connected to the magnet assembly, the transducer device comprises a frame connected to the first magnetic conductive member, the inner ring fixation portion is connected to a center region of the frame, or the inner ring fixation portion is connected to an edge region of the frame.

In some implementations, the frame includes two end caps spaced apart in the axial direction, and the two end caps are connected to two ends of the first magnetic conductive member in the axial direction, respectively.

In some implementations, at least a portion of the first magnetic conductive member is made of a hard magnetic material.

In some embodiments, the at least one first vibration transmission plate includes two first vibration transmission plates, and the two first vibration transmission plates are located on opposite sides of the first coil in the axial direction, respectively.

In some embodiments, each of the two first vibration transmission plates includes an inner ring fixation portion and an outer ring fixation portion nested with each other, and a plurality of spoke portions connecting the inner ring fixation portion and the outer ring fixation portion, each of the plurality of spoke portions spirally expands from the inner ring fixation portion to the outer ring fixation portion, and when viewed along the axial direction, a spiral direction of the plurality of spoke portions of one first vibration transmission plate in the two first vibration transmission plates is opposite to a spiral direction of the plurality of spoke portions of another first vibration transmission plate in the two first vibration transmission plates.

In some embodiments, the first magnetic conductive member is configured to be fixed relative to the first coil, the first magnetic conductive member includes a first main body portion and a first extension portion connected to the first main body portion, the first coil surrounds a periphery of the first main body portion, the first extension portion is spaced apart from the magnet assembly in the axial direction, an orthographic projection of the first main body portion on a reference plane perpendicular to the axial direction does not overlap with an orthographic projection of the magnet assembly on the reference plane, an orthographic projection of the first extension portion on the reference plane overlaps with the orthographic projection of the magnet assembly on the reference plane, and a distance between the first main body portion and the magnet assembly in the radial direction is less than a distance between the first extension portion and the magnet assembly in the axial direction.

In some implementations, the transducer device comprises a cushioning member disposed on an inner side of the magnet assembly, the cushioning member is disposed on at least one side of the first coil in the axial direction, and a dimension of the cushioning member in the radial direction is not less than half a dimension of the one first coil in the radial direction.

In some embodiments, the transducer device comprises a first magnetic conductive member, the first coil surrounds a periphery of the first magnetic conductive member, the first magnetic conductive member is configured to be fixed relative to the first coil, and the cushioning member is fixed to the first magnetic conductive member.

In some embodiments, the magnet assembly includes a hard magnet, the first coil includes two first sub-coils spaced apart in the axial direction, and a distance between a center dividing plane of one of the two first sub-coils and an end surface of the hard magnet in the axial direction is less than or equal to half a dimension of the one first sub-coil in the axial direction.

In some implementations, the two first sub-coils are connected in series with each other and wound in opposite directions.

In some embodiments, the magnet assembly includes two soft magnets, the two soft magnets are connected to two end surfaces of the hard magnet, respectively, and a distance between the center dividing plane of one of the two first sub-coils and a center dividing plane of one of the two soft magnets in the axial direction is less than or equal to half the dimension of the first sub-coil in the axial direction.

In some embodiments, the magnet assembly includes a plurality of hard magnets arranged along the axial direction, any two adjacent hard magnets in the plurality of hard magnets are opposite to each other with the same polarity, and the first coil includes at least one first sub-coil, and at least one of the at least one first sub-coil overlaps with two adjacent hard magnets in the axial direction.

In some embodiments, the plurality of hard magnets includes two hard magnets, the first coil includes a first sub-coil, and the first sub-coil overlaps with the two hard magnets in the axial direction.

In some embodiments, the at least one first vibration transmission plate is made of a soft magnetic material.

In some implementations, the at least one first sub-coil includes a plurality of first sub-coils, and a count of the plurality of first sub-coils is unequal to a count of the plurality of hard magnets.

In some embodiments, the count of the plurality of first sub-coils is less than the count of the plurality of hard magnets, any one of the plurality of first sub-coils overlaps with two adjacent hard magnets in the axial direction, and the at least one first vibration transmission plate is made of a soft magnetic material.

In some embodiments, the plurality of first sub-coils are connected in series with each other, and any two adjacent first sub-coils are wound in opposite directions.

In some implementations, the magnet assembly includes a plurality of soft magnets, and the plurality of soft magnets and the plurality of hard magnets are disposed in an alternating manner in the axial direction.

In some embodiments, the transducer device includes a second coil surrounding a periphery of the magnet assembly, the second coil is spaced apart from the magnet assembly in the radial direction, and the second coil and the magnet assembly at least partially overlap with each other in the axial direction, and in an operation state in which the transducer device is input with a second excitation signal, the second coil is energized and generates a second Ampere force in the magnetic field, and the second Ampere force causes the second coil to move relative to the magnet assembly.

In some implementations, the second coil is configured to be fixed relative to the first coil.

In some implementations, the second coil and the first coil are connected in series with each other.

In some embodiments, the transducer device comprises a second magnetic conductive member, at least a portion of the second magnetic conductive member surrounds a periphery of the second coil, and the second magnetic conductive member and the magnet assembly at least partially overlap with each other in the axial direction.

In some implementations, the second magnetic conductive member is configured to be fixed relative to the magnet assembly, and at least a portion of the second magnetic conductive member is spaced from the second coil in the radial direction.

In some embodiments, the second magnetic conductive member includes a second main body portion and a second extension portion connected to the second main body portion, the second main body portion has a hollow structure, the second main body portion surrounds the periphery of the second coil and is spaced from the second coil in the radial direction, and the second extension portion is connected to the magnet assembly and spaced from the second coil in the axial direction.

In some embodiments, the second magnetic conductive member is configured to be fixed relative to the second coil.

In some embodiments, a distance between the second coil and the second magnetic conductive member in the radial direction is less than a distance between the second coil and the magnet assembly in the radial direction.

In some embodiments, at least a portion of the second magnetic conductive member is made of a hard magnetic material.

In some embodiments, the magnet assembly includes a hard magnet, the second coil includes two second sub-coils spaced apart in the axial direction, and a distance between a center dividing plane of one of the two second sub-coils and an end surface of the hard magnet in the axial direction is less than or equal to half a dimension of the one second sub-coil in the axial direction.

In some implementations, the two second sub-coils are connected in series with each other and wound in opposite directions.

In some embodiments, the magnet assembly includes two soft magnets, the two soft magnets are connected to two end surfaces of the hard magnet, respectively, and a distance between the center dividing plane of one of the two second sub-coils and a center dividing plane of one of the two soft magnets in the axial direction is less than or equal to half of the dimension of the one second sub-coil in the axial direction.

In some embodiments, the magnet assembly includes a plurality of hard magnets arranged along the axial direction, any two adjacent hard magnets in the plurality of hard magnets are opposite to each other with the same polarity, and the second coil includes at least one second sub-coil, and at least one of the at least one first sub-coil second sub-coil overlaps with two adjacent hard magnets in the axial direction.

In some embodiments, the plurality of hard magnets includes two hard magnets, the second coil includes a second sub-coil, and the second sub-coil overlaps with the two hard magnets in the axial direction.

In some implementations, the at least one second sub-coil includes a plurality of second sub-coils, and a count of the plurality of second sub-coils is unequal to a count of the plurality of hard magnets.

In some embodiments, the plurality of second sub-coils are connected in series with each other, and any two adjacent second sub-coils are wound in opposite directions.

In some embodiments, the magnet assembly includes a plurality of soft magnets, and the plurality of soft magnets and the plurality of hard magnets are disposed in an alternating manner in the axial direction.

In some implementations, the second excitation signal is not the same as the first excitation signal.

Embodiments of the present disclosure provide a core module, comprising a core housing and a transducer device. The transducer device is provided in an accommodation cavity of the core housing.

In some embodiments, the core module comprises at least one second vibration transmission plate and a vibration panel. The transducer device is suspended in the accommodation cavity through the at least one second vibration transmission plate, and the vibration panel is connected to the transducer device.

In some embodiments, the at least one second vibration transmission plate includes two second vibration transmission plates, and the two second vibration transmission plates are located on opposite sides of the transducer device in the axial direction, respectively.

In some embodiments, the core housing includes a cylindrical side wall and an end wall, the end wall is connected to one end of the cylindrical side wall such that the other end of the cylindrical side wall is open, and the core module includes a resilient cladding layer connected to the vibration panel, and the resilient cladding layer is connected to the other end of the cylindrical side wall.

In some embodiments, the core housing includes a cylindrical side wall, and a first end wall and a second end wall connected to two ends of the cylindrical side wall, respectively, the first end wall is provided with a mounting hole, the transducer device is located between the first end wall and the second end wall, the vibration panel includes a main body portion and a connection portion connected to the main body portion, the main body portion is located outside the core housing, the connection portion extends into the core housing through the mounting hole and is connected to the transducer device. When viewed along the axial direction, an area of the main body portion is greater than an area of the mounting hole, and the area of the mounting hole is greater than an area of the connection portion.

In some embodiments, the accommodation cavity communicates with an exterior of the core module through one single channel, and the channel is a gap between the connection portion and a wall of the mounting hole.

Embodiments of the present disclosure provide an electronic device, comprising a support assembly and a core module. The support assembly is connected to the core housing and is configured to support the core module to be worn at a wearing position.

In some implementations, the electronic device comprises a housing connected to the support assembly, and the core module is assembled as a module within the housing.

The beneficial effects of the present disclosure include that, in the transducer device provided by the present disclosure, relative movement between the first coil and the magnet assembly is driven by an Ampere force generated by the energized first coil in the magnetic field, without the need for structural components such as a core and a magnetic conductive plate. This eliminates the weight of the core and the magnetic conductive plate, which improves the sensitivity of the transducer device. Additionally, the frequency response curve of the transducer device remains flat in a high-frequency band (e.g., frequencies greater than or equal to 5 kHz), while the resonance peak in the low-frequency band can shift to a band of lower frequency. For example, a peak resonance frequency of a low-frequency resonance peak is less than or equal to 500 Hz.

### BRIEF DESCRIPTION OF THE DRAWINGS

In order to more clearly illustrate the technical solutions in the embodiments of the present disclosure, the accompanying drawings that need to be used in the description of the embodiments will be briefly introduced in the following, and it will be obvious that the accompanying drawings in the description in the following are only some of the embodiments of the present disclosure, and other attachments can also be obtained without creative labor to those skilled in the art.

FIG. 1 is a schematic diagram illustrating an exemplary structure of a transducer device according to one embodiment of the present disclosure;

FIG. 2 is a schematic diagram illustrating an exemplary structure of a transducer device according to one embodiment of the present disclosure;

FIG. 3 is a schematic diagram illustrating an exemplary structure of a transducer device according to one embodiment of the present disclosure;

FIG. 4 is a schematic diagram illustrating an exemplary structure of a transducer device according to one embodiment of the present disclosure;

FIG. 5 is a schematic diagram illustrating an exemplary structure of a first vibration transmission plate according to one embodiment of the present disclosure;

FIG. 6 is a schematic diagram illustrating an exemplary structure of a transducer device according to one embodiment of the present disclosure;

FIG. 7 is a schematic diagram illustrating an exemplary structure of a transducer device according to one embodiment of the present disclosure;

FIG. 8 is a schematic diagram illustrating an exemplary structure of a transducer device according to one embodiment of the present disclosure;

FIG. 9 is a schematic diagram illustrating an exemplary structure of a transducer device according to one embodiment of the present disclosure;

FIG. 10 is a schematic diagram illustrating an exemplary structure of a transducer device according to one embodiment of the present disclosure;

FIG. 11 is a schematic diagram illustrating an exemplary structure of a transducer device according to one embodiment of the present disclosure;

FIG. 12 is a schematic diagram illustrating an exemplary structure of a transducer device according to one embodiment of the present disclosure;

FIG. 13 is a schematic diagram illustrating an exemplary structure of a transducer device according to one embodiment of the present disclosure;

FIG. 14 is a schematic diagram illustrating an exemplary structure of a transducer device according to one embodiment of the present disclosure;

FIG. 15 is a schematic diagram illustrating an exemplary structure of a transducer device according to one embodiment of the present disclosure;

FIG. 16 is a schematic diagram illustrating an exemplary structure of a transducer device according to one embodiment of the present disclosure;

FIG. 17 is a schematic diagram illustrating an exemplary structure of a transducer device according to one embodiment of the present disclosure;

FIG. 18 is a schematic diagram illustrating an exemplary structure of a transducer device according to one embodiment of the present disclosure;

FIG. 19 is a schematic diagram illustrating an exemplary structure of a transducer device according to one embodiment of the present disclosure;

FIG. 20 is a schematic diagram illustrating an exemplary structure of a transducer device according to one embodiment of the present disclosure;

FIG. 21 is a schematic diagram illustrating an exemplary structure of a transducer device according to one embodiment of the present disclosure;

FIG. 22 is a schematic diagram illustrating an exemplary structure of a transducer device according to one embodiment of the present disclosure;

FIG. 23 is a schematic diagram illustrating an exemplary structure of a transducer device according to one embodiment of the present disclosure;

FIG. 24 is a schematic diagram illustrating an exemplary structure of a transducer device according to one embodiment of the present disclosure;

FIG. 25 is a schematic diagram illustrating an exemplary structure of a transducer device according to one embodiment of the present disclosure;

FIG. 26 is a schematic diagram illustrating an exemplary structure of a transducer device according to one embodiment of the present disclosure;

FIG. 27 is a schematic diagram illustrating an exemplary structure of a core module according to one embodiment of the present disclosure;

FIG. 28 is a schematic diagram illustrating an exemplary structure of a core module according to one embodiment of the present disclosure;

FIG. 29 is a schematic diagram illustrating an exemplary structure of a core module according to one embodiment of the present disclosure;

FIG. 30 is a schematic diagram illustrating an exemplary structure of a core module according to one embodiment of the present disclosure;

FIG. 31 is a schematic diagram illustrating an exemplary structure of a core module according to one embodiment of the present disclosure;

FIG. 32 is a schematic diagram illustrating an exemplary structure of a core module according to one embodiment of the present disclosure;

(a) to (c) in FIG. 33 are schematic diagrams illustrating exemplary structures of an electronic device in a wearing state according to embodiments of the present disclosure.

FIG. 34 is a graph illustrating a comparison of frequency response curves of a transducer device according to embodiments of the present disclosure; and

FIG. 35 is a graph illustrating a comparison of frequency response curves of a transducer device according to embodiments of the present disclosure.

### DETAILED DESCRIPTION

The present disclosure is described in further detail below in conjunction with the accompanying drawings and embodiments. In particular, it is noted that the following embodiments are only used to illustrate the present disclosure, but do not limit the scope of the present disclosure. Similarly, the following embodiments are only part of the embodiments of the present disclosure rather than all of the embodiments, and all other embodiments obtained by those skilled in the art without creative labor fall within the scope of protection of the present disclosure.

References to “embodiments” in the present disclosure mean that particular features, structures, or characteristics described in conjunction with embodiments may be included in at least one embodiment of the present disclosure. It is understood by those skilled in the art, both explicitly and implicitly, that the embodiments described in the present disclosure may be combined with other embodiments.

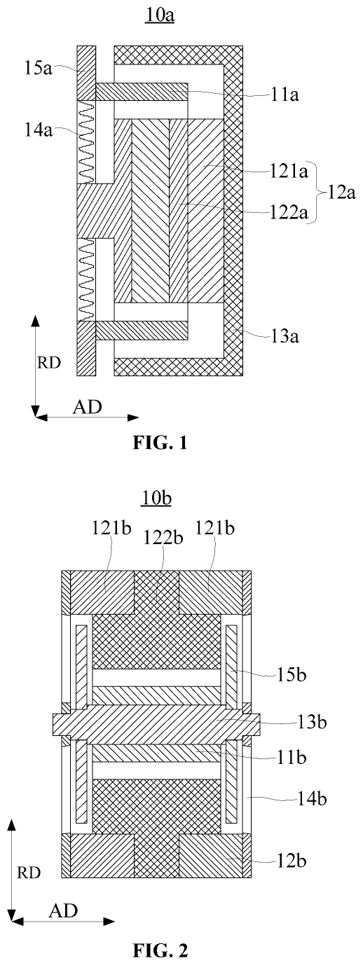

For example, in conjunction with FIG. 1, a transducer device 10a includes a coil 11a, a magnet assembly 12a, a magnetic conductive cover 13a, a vibration transmission plate 14a, and a frame 15a. The magnet assembly 12a is secured to a bottom of the magnetic conductive cover 13a along an axial direction AD of the transducer device 10a and forms a magnetic gap with the magnetic conductive cover 13a in a radial direction RD of the transducer device 10a. The frame 15a is connected to the magnet assembly 12a through the vibration transmission plate 14a. The coil 11a is connected to the frame 15a and extends into the magnetic gap. Further, the magnet assembly 12a includes hard magnets 121a connected to the bottom of the magnetic conductive cover 13a and magnetic conductive plates 122a connected to the hard magnets 121a. A count of the hard magnets 121a may exceed one and a count of the magnetic conductive plates 122a may exceed one. Based on this, in an operation state in which the transducer device 10a is input with an excitation signal, the coil 11a, after being energized, generates an Ampere force in a magnetic field formed by the magnet assembly 12a and the magnetic conductive cover 13a. The Ampere force causes the coil 11a (and the frame 15a) to move relative to the magnet assembly 12a (and the magnetic conductive cover 13a), thereby converting the excitation signal into a corresponding mechanical vibration.

For example, in conjunction with FIG. 2, the transducer device 10b includes a coil 11b, a magnet assembly 12b, an iron core 13b, a vibration transmission plate 14b, and a magnetic conductive plate 15b. The coil 11b may be wound on the iron core 13b, and two ends of the iron core 13b may be fixed with a magnetic conductive plate 15b, respectively. The magnet assembly 12b surrounds a periphery of the coil 11b and a periphery of the magnetic conductive plate 15b. Two ends of the iron core 13b may be connected to the magnet assembly 12b through a vibration transmission plate 14b, respectively. The magnet assembly 12b may include two hard magnets 121b and a magnetic conductive member 122b partially sandwiched between the two hard magnets 121b, the two hard magnets 121b being opposite to each other with the same polarity. Further, the coil 11b and the magnetic conductive plate 15b are spaced apart from the magnet assembly 12b in the radial direction RD of the transducer device 10b, a projection of the magnetic conductive plate 15b overlaps with a projection of the magnet assembly 12b (specifically the magnetic conductive member 122b) in the axial direction AD of the transducer device 10b, and a distance between the iron core 13b and the magnet assembly 12b (specifically the magnetic conductive member 122b) in the radial direction RD is greater than a distance between the magnetic conductive plate 15b and the magnet assembly 12b (specifically the magnetic conductive member 122b) in the axial direction AD. Based on this, in an operation state in which the transducer device 10b is input with an excitation signal, the energized coil 11b magnetizes the iron core 13b and the magnetic conductive plate 15b so that the two attract or repel with the magnet assembly 12b, causing the coil 11b (and the iron core 13b and the magnetic conductive plate 15b) to move relative to the magnet assembly 12b, thereby converting the excitation signal into a corresponding mechanical vibration.

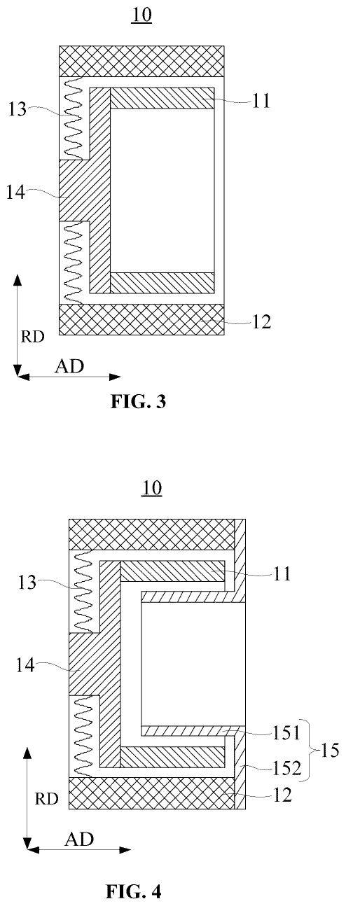

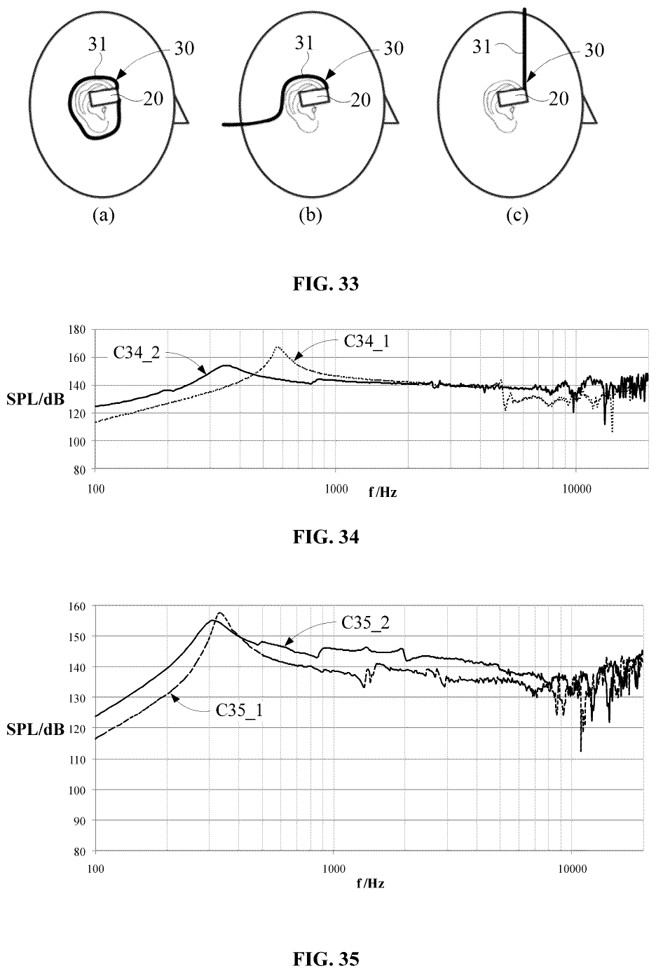

For example, in conjunction with FIG. 3, the transducer device 10 includes the first coil 11 and the magnet assembly 12, and the first vibration transmission plate 13 connects the first coil 11 and the magnet assembly 12. The magnet assembly 12 surrounds the periphery of the first coil 11, and the magnet assembly 12 is spaced apart from the first coil 11 in a radial direction RD of the transducer device 10 and at least partially overlaps with the first coil 11 in an axial direction AD of the transducer device 10, i.e., an orthographic projection of the magnet assembly 12 at least partially overlaps with an orthographic projection of the first coil 11 on a reference plane perpendicular to the radial direction RD. Based on this, in an operation state in which the transducer device 10 is input with a first excitation signal, the energized first coil 11 generates a first Ampere force in a magnetic field formed by the magnet assembly 12 that causes the first coil 11 to move relative to the magnet assembly 12, thereby converting the first excitation signal into a corresponding mechanical vibration. In such cases, compared with a technical solution described in FIG. 2, a relative movement between the first coil 11 and the magnet assembly 12 in the technical solution shown in FIG. 3 originates from an Ampere force generated by an energized coil in a magnetic field, and structural components such as the iron core 13b and the magnetic conductive plate 15b are not required, so the weights of the iron core 13b and the magnetic conductive plate 15b are eliminated, which is conducive to improving the sensitivity of the transducer device 10. In addition, in combination with FIG. 34, compared to a frequency response curve of the technical solution shown in FIG. 2 (e.g., shown as a curve C34_1 in FIG. 34), a frequency response curve of the technical solution shown in FIG. 3 (e.g., shown as a curve C34_2 in FIG. 34) is still flat in a high-frequency band (e.g., at a frequency greater than or equal to 5 kHz), and a resonance peak in a low-frequency band is shifted to a frequency band of lower frequencies, e.g., a peak resonance frequency of the low-frequency resonance peak is less than or equal to 500 Hz. The reason why the frequency response curve of the technical solution shown in FIG. 3 is still flat in the high-frequency band is as follows: in a case where the length of a wire for making a coil is constant, in the technical solution described in FIG. 2, due to a relatively small radial dimension of the coil 11b, the coil 11b needs to be wound more turns, i.e., a count of turns of the coil 11b is larger, causing a structure composed of the coil 11b, the iron core 13b, and the magnetic conductive plate 15b to have a higher inductance in the high-frequency band, resulting in a larger impedance in the high-frequency band, which in turn results in a decrease in a sensitivity in the high-frequency band. However, in the technical solution described in FIG. 3, the radial dimension of the first coil 11 is larger, and the count of turns of the first coil 11 is smaller, which is conducive to reducing an inductance in the high-frequency band, and avoiding the decrease of the sensitivity in the high-frequency band, thereby making a corresponding frequency response curve flatter in the high-frequency band. The reason why the resonance peak of the frequency response curve of the technical solution shown in FIG. 3 in the low-frequency band is shifted to the frequency band of lower frequencies is as follows: in the technical solution described in FIG. 2, since an orthographic projection of the magnetic conductive plate 15b at least partially overlaps with an orthographic projection of the magnet assembly 12b (specifically the magnetic conductive member 122b) in the axial direction AD, the vibration transmission plate 14b needs to avoid direct magnetic adsorption between the magnetic conductive plate 15b and the magnet assembly 12b (specifically the magnetic conductive member 122b) in the axial direction AD, resulting in a larger stiffness of the vibration transmission plate 14b in the axial direction AD, which in turn leads to a larger peak resonance frequency of a low-frequency resonance peak of a corresponding frequency response curve. However, in the technical solution described in FIG. 3, due to a difference between an operation principle of the transducer device 10 and an operation principle of the transducer device 10b in FIG. 2, there is no need to worry about the magnetic adsorption in the axial direction AD, which is conducive to reducing the stiffness of the first vibration transmission plate 13 in the axial direction AD, such that a peak resonance frequency of a low-frequency resonance peak of a corresponding frequency response curve can be shifted toward a frequency band of lower frequencies.

In some embodiments, compared to the technical solution described in FIG. 1, the inner side of the first coil 11 is not provided with a hard magnet, which is conducive to avoiding sound leakage of the transducer device 10 due to an acoustic cavity effect. In conjunction with FIG. 1, the acoustic cavity effect refers to that, when the coil 11a moves relative to the magnet assembly 12a (and the magnetic conductive cover 13a), a pressure of the air within a magnetic gap between the magnet assembly 12a and the magnetic conductive cover 13a changes consequently, thereby generating sound leakage.

In some embodiments, the transducer device 10 includes a first frame 14 connected to the first coil 11, such that the first coil 11 is connected to the first vibration transmission plate 13 through the first frame 14. The first frame 14 may be made of a soft magnetic material or a plastic material. In such cases, compared to the technical solution depicted in FIG. 1, the first frame 14 in the technical solution described in FIG. 3 can not only be made larger in the axial direction AD, for example, thickened in a direction along the axial direction AD and away from the first vibration transmission plate 13, but also smaller in the radial direction RD, which is conducive to improving the stiffness of the first frame 14 and making a high-frequency resonance peak of the transducer device 10 shift to a frequency band of higher frequencies (for example, greater than 7 kHz), thereby improving a high-frequency mode. In addition to this, leads of the first coil 11 may be secured to a side of the first frame 14 that is away from the first vibration transmission plate 13 through a medium such as glue, so that, even if the glue bulges after curing, it will not interfere with other structural components.

In some embodiments, the transducer device 10 includes a first magnetic conductive member 15, and the first coil 11 surrounds a periphery of the first magnetic conductive member 15. The first magnetic conductive member 15 at least partially overlaps with the magnet assembly 12 in the axial direction AD, i.e., an orthographic projection of the first magnetic conductive member 15 overlaps at least partially with an orthographic projection of the magnet assembly 12 on a reference plane perpendicular to the radial direction RD, so that magnetic flux lines of a magnetic field generated by the magnet assembly 12 are more concentrated and more magnetic flux lines can pass through the first coil 11, i.e., magnetic flux leakage is reduced, which is conducive to improving a sensitivity of the transducer device 10.

In some embodiments, a ratio between the dimension of the first magnetic conductive member 15 in the axial direction AD to the dimension of the first coil 11 in the axial direction AD is greater than or equal to 1. When the dimension of the first coil 11 in the axial direction AD is constant, if the dimension of the first magnetic conductive member 15 in the axial direction AD is too small, the magnetic flux lines of the magnetic field generated by the magnet assembly 12 may be difficult to pass through the first coil 11 more, i.e., more magnetic flux leakage occurs.

In some embodiments, compared to the technical solution described in FIG. 2, the first magnetic conductive member 15 has a hollow structure, which is conducive to both reducing the sound leakage of the transducer device 10 and improving the sensitivity of the transducer device 10, which will be illustrated in subsequent descriptions. In addition, in conjunction with FIG. 34, compared to the frequency response curve of the technical solution depicted in FIG. 2 (e.g., shown as the curve C34_1 in FIG. 34), the frequency response curve of the technical solution described in FIG. 3 (e.g., shown as the curve C34_2 in FIG. 34) remains flat in the high-frequency band (e.g., at a frequency greater than or equal to 5 kHz). This is because in the technical solution described in FIG. 2, since the iron core 13b is a solid structure, the structure composed of the coil 11b, the iron core 13b, and the magnetic conductive plate 15b has a higher inductance in the high-frequency band, resulting in a higher impedance in the high-frequency band, which in turn results in a decrease in the sensitivity in the high-frequency band. However, in the technical solution described in FIG. 3, the first magnetic conductive member 15 has a hollow structure, which is conducive to reducing the inductance in the high-frequency band, avoiding a decrease in the sensitivity in the high-frequency band, and making a corresponding frequency response curve flatter in the high-frequency band. Furthermore, the ratio between the dimension of the first magnetic conductive member 15 in the radial direction RD to the dimension of the first coil 11 in the radial direction RD is within a range of 0.5 to 1.5. When the dimension of the first coil 11 in the radial direction RD is constant, if the dimension of the first magnetic conductive member 15 in the radial direction RD is too small, it tends to lead to insufficient structural strength of the first magnetic conductive member 15. If the dimension of the first magnetic conductive member 15 in the radial direction RD is too large, it tends to lead to a large inductance in the high-frequency band.

In some embodiments, in conjunction with FIG. 4, the first magnetic conductive member 15 is configured to be fixed relative to the magnet assembly 12, with at least a portion of the first magnetic conductive member 15 spaced apart from the first coil 11 in the radial direction RD. In such cases, the first magnetic conductive member 15 may move relative to the first coil 11 following the magnet assembly 12, which is conducive to improving the sensitivity of the transducer device 10.

In some embodiments, the first magnetic conductive member 15 includes a first main body portion 151 and a first extension portion 152 connected to the first main body portion 151, and the first extension portion 152 extends toward an outer side of the first main body portion 151 along the radial direction RD. The first coil 11 surrounds a periphery of the first main body portion 151 and is spaced apart from the first main body portion 151 in the radial direction RD, and the first extension portion 152 is connected to the magnet assembly 12 and is spaced apart from the magnet assembly 12 in the axial direction AD. Furthermore, the first magnetic conductive member 15 may be entirely magnetically conductive, for example, the first main body portion 151 and the first extension portion 152 are made of a soft magnetic material. The first magnetic conductive member 15 may be partially magnetically conductive, for example, the first main body portion 151 and the first extension portion 152 are made of a soft magnetic material and a plastic material, respectively. The first main body portion 151 and the first extension portion 152 may be an integrally-molded structural component.

In some embodiments, the first main body portion 151 has a hollow structure, which is not only beneficial to reduce the weight of the transducer device 10, but also beneficial to avoid the sound leakage of the transducer device 10 due to the acoustic cavity effect.

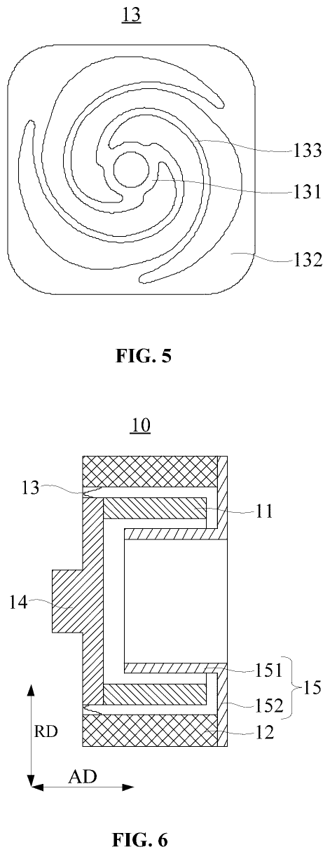

In some embodiments, in conjunction with FIG. 4 and FIG. 5, the first vibration transmission plate 13 includes an inner ring fixation portion 131 and an outer ring fixation portion 132 nested with each other, and a plurality of spoke portions 133 connecting the inner ring fixation portion 131 and the outer ring fixation portion 132. The plurality of spoke portions 133 allow the inner ring fixation portion 131 and the outer ring fixation portion 132 to move relative to each other at least in the axial direction AD under an action of an external force. Further, the outer ring fixation portion 132 may be connected to the magnet assembly 12, and the inner ring fixation portion 131 may be connected to a center region of the first frame 14 to allow the first coil 11 and the magnet assembly 12 to move relative to each other under an Ampere force.

In some embodiments, in conjunction with FIG. 6 and FIG. 5, the first vibration transmission plate 13 includes the inner ring fixation portion 131 and the outer ring fixation portion 132 nested with each other, and a plurality of spoke portions 133 connecting the inner ring fixation portion 131 and the outer ring fixation portion 132. The plurality of spoke portions 133 allow the inner ring fixation portion 131 and the outer ring fixation portion 132 to move relative to each other at least in the axial direction AD direction under an action of an external force. Further, the outer ring fixation portion 132 may be connected to the magnet assembly 12, and the inner ring fixation portion 131 may be connected to an edge region of the first frame 14 to allow the first coil 11 and the magnet assembly 12 to move relative to each other under an Ampere force. It should be noted that: compared to a technical solution described in FIG. 5, the bending degree of the spoke portion 133 in a technical solution described in FIG. 6 is smaller, and the probability of stress concentration under extreme working conditions such as the occurrence of a drop of the transducer device 10 is smaller, which is conducive to improving the reliability of the first vibration transmission plate 13. In addition, compared with the technical solution described in FIG. 5, the technical solution described in FIG. 6 does not need to reserve a safety gap between the first vibration transmission plate 13 and the first frame 14 in the axial direction AD, which is conducive to reducing an axial dimension of the transducer device 10.

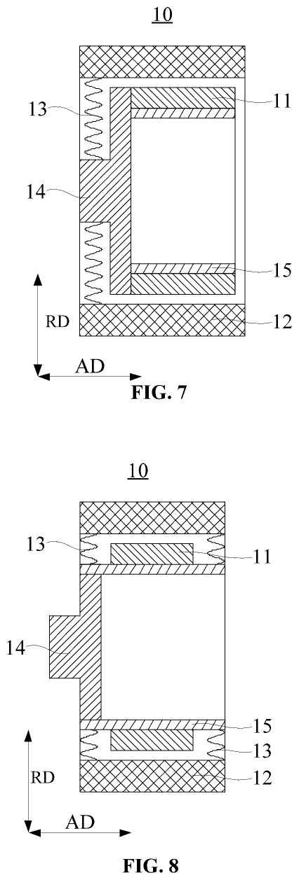

In some embodiments, in conjunction with FIG. 7, the first magnetic conductive member 15 is configured to be fixed relative to the first coil 11, and an orthographic projection of the first magnetic conductive member 15 on a reference plane perpendicular to the axial direction AD does not overlap with an orthographic projection of the magnet assembly 12 on the reference plane perpendicular to the axial direction AD. In such cases, the first magnetic conductive member 15 may move relative to the magnet assembly 12 following the first coil 11, which is not only conducive to simplifying the structure of the first magnetic conductive member 15, but also conducive to further mitigating (or even eliminating) the sound leakage of the transducer device 10 due to the acoustic cavity effect.

Furthermore, the first magnetic conductive member 15 may have a hollow structure, so that the total weight of the first magnetic conductive member 15 and the first coil 11 is not too large, which is not only conducive to reducing the weight of the transducer device 10, but also conducive to increasing sensitivity of the transducer device 10.

In some embodiments, an orthographic projection of the first coil 11 on a reference plane perpendicular to the radial direction RD, the orthographic projection of the magnet assembly 12 on the reference plane perpendicular to the radial direction RD, and the orthographic projection of the first magnetic conductive member 15 on the reference plane perpendicular to the radial direction RD at least partially overlap. A distance between an overlapping region of the first magnetic conductive member 15 and an overlapping region of the magnet assembly 12 in the radial direction RD is less than or equal to 1.5 times the minimum distance between the first magnetic conductive member 15 and the magnet assembly 12, such that magnetic flux lines of a magnetic field generated by the magnet assembly 12 is more concentrated and more magnetic flux lines can pass through the first coil 11, i.e., the magnetic leakage is reduced, which is conducive to improving the sensitivity of the transducer device 10. It should be noted that: in the technical solution depicted in FIG. 2, since a distance between the iron core 13b and the magnet assembly 12b (specifically the magnetic conductive member 122b) in the radial direction RD is greater than a distance between the magnetic conductive plate 15b and the magnet assembly 12b (specifically the magnetic conductive member 122b) in the axial direction AD, less magnetic flux lines of a magnetic field formed by the magnet assembly 12b may pass through the coil 11b. However, in a technical solution described in FIG. 7, the magnetic flux lines of the magnetic field generated by the magnet assembly 12 are more concentrated, and more magnetic flux lines can pass through the first coil 11. Furthermore, in the embodiment as shown in FIG. 7, a distance between an overlapping region of the first magnetic conductive member 15 and an overlapping region of the magnet assembly 12 in the radial direction RD is equal to a minimum distance between the first magnetic conductive member 15 and the magnet assembly 12.

In some embodiments, a distance between the first coil 11 and the first magnetic conductive member 15 in the radial direction RD is less than the distance between the first coil 11 and the magnet assembly 12 in the radial direction RD, for example, the first coil 11 is wrapped around the first magnetic conductive member 15. In such cases, compared to a technical solution described in FIG. 4, a magnetic gap between the first magnetic conductive member 15 and the magnet assembly 12 in the radial direction RD is smaller in the technical solution described in FIG. 7, which is conducive to improving the sensitivity of the transducer device 10.

In some embodiments, in conjunction with FIG. 8 and FIG. 7, the first vibration transmission plate 13 includes an inner ring fixation portion 131 and an outer ring fixation portion 132 nested with each other, and a plurality of spoke portions 133 connecting the inner ring fixation portion 131 and the outer ring fixation portion 132. The plurality of spoke portions 133 allow the inner ring fixation portion 131 and the outer ring fixation portion 132 to move relative to each other at least in the axial direction AD direction under an action of an external force. Further, the outer ring fixation portion 132 is connected to the magnet assembly 12, and the inner ring fixation portion 131 is connected to the first magnetic conductive member 15 to allow the first coil 11 and the magnet assembly 12 to move relative to each other under an Ampere force. There may be two first vibration transmission plates 13, and the two first vibration transmission plates 13 are located on opposite sides of the first coil 11 in the axial direction AD, which is conducive to reducing the risk of magnetic absorption between the first magnetic conductive member 15 and the magnet assembly 12, especially in extreme working conditions such as dropping. Further, each of the plurality of spoke portions 130 spirally expands from the inner ring fixation portion 131 to the outer ring fixation portion 132. When viewed along the axial direction AD, a spiral direction of the plurality of spoke portions 130 of one first vibration transmission plate 13 in the two first vibration transmission plates 13 is opposite to a spiral direction of the plurality of spoke portions 130 of the other first vibration transmission plate 13 in the two first vibration transmission plates 13. In such cases, when the first coil 11 and the magnet assembly 12 tend to twist around the axial direction AD, one of the two first vibration transmission plates 13 can hinder such a twisting tendency, thus avoiding unwanted collision and further reducing the magnetic gap between the first magnetic conductive member 15 and the magnet assembly 12 in the radial direction RD. It should be noted that: in an embodiment in which the transducer device 10 includes the first frame 14 connected to the first magnetic conductive member 15, the connection between the inner ring fixation portion 131 and the first magnetic conductive member 15 may also be regarded as that the inner ring fixation portion 131 is connected to an edge region of the first frame 14.

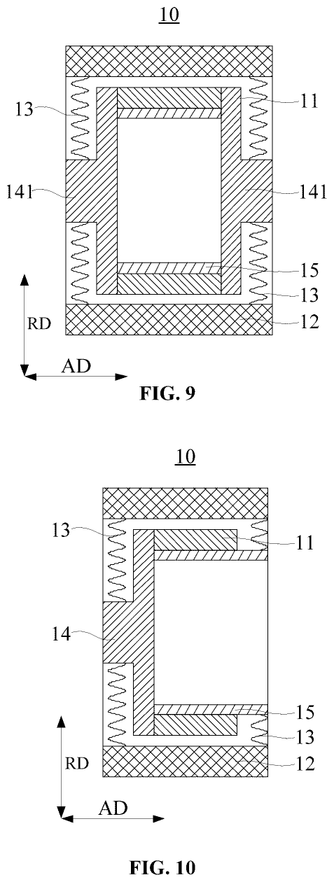

In some embodiments, in conjunction with FIG. 9 and FIG. 5, the first vibration transmission plate 13 includes an inner ring fixation portion 131 and an outer ring fixation portion 132 nested with each other and a plurality of spoke portions 133. The plurality of spoke portions 133 allow the inner ring fixation portion 131 and the outer ring fixation portion 132 to move relative to each other at least in an axial direction AD direction under an action of an external force. Further, the outer ring fixation portion 132 is connected to the magnet assembly 12, and the inner ring fixation portion 131 is connected to a center region of the first frame 14 to allow the first coil 11 and the magnet assembly 12 to move relative to each other under an Ampere force.

Furthermore, the first frame 14 includes two first end caps 141 spaced apart in the axial direction AD, and the two first end caps 141 are connected to two ends of the first magnetic conductive member 15 in the axial direction AD, respectively. Similarly, there may be two first vibration transmission plates 13 located on opposite sides of the first coil 11 in the axial direction AD. An inner ring fixation portion 131 of one first vibration transmission plate 13 is connected to a center region of one first end cap 141, and an inner ring fixation portion 131 of the other first vibration transmission plate 13 is connected to a center region of the other first end cap 141.

In some embodiments, in conjunction with FIG. 10, FIG. 5, and FIG. 7, the first vibration transmission plate 13 includes an inner ring fixation portion 131 and an outer ring fixation portion 132 nested with each other, and a plurality of spoke portions 133 connecting the inner ring fixation portion 131 and the outer ring fixation portion 132. The plurality of spoke portions 133 allow the inner ring fixation portion 131 and the outer ring fixation portion 132 to move relative to each other at least in the axial direction AD under an action of an external force. Further, there may be two first vibration transmission plates 13 located on opposite sides of the first coil 11 in the axial direction AD. Outer ring fixation portions 132 of the two first vibration transmission plates 13 are connected to the magnet assembly 12, respectively, an inner ring fixation portion 131 of one first vibration transmission plate 13 is connected to a center region of the first frame 14, and an inner ring fixation portion 131 of the other first vibration transmission plate 13 is connected to the first magnetic conductive member 15, so as to allow the first coil 11 and the magnet assembly 12 to move relative to each other under an Ampere force.

In some embodiments, at least a portion of the first magnetic conductive member 15 may be made of a hard magnetic material. For example, the first magnetic conductive member 15 includes a hard magnet and a soft magnet stacked along the axial direction AD. In such cases, the first magnetic conductive member 15 may magnetically attract soft magnets such as nickel steel sheets, silicon steel sheets, soft magnetic ferrites, or the like.

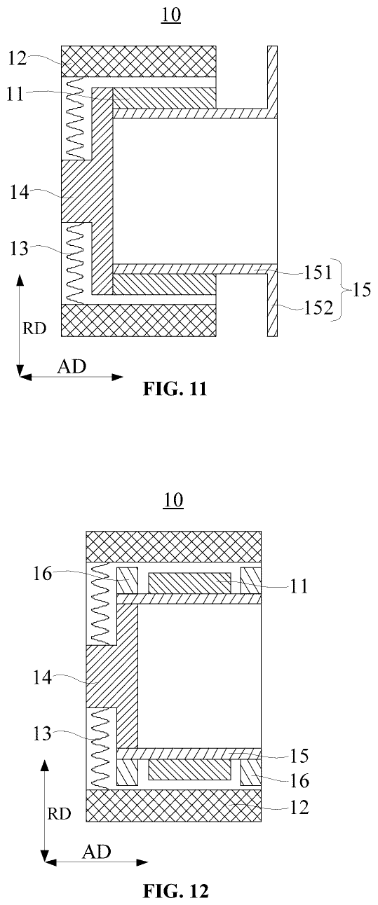

In some embodiments, in conjunction with FIG. 11, the first magnetic conductive member 15 is configured to be fixed relative to the first coil 11. The first magnetic conductive member 15 may include the first main body portion 151 and the first extension portion 152 connected to the first main body portion 151, and the first extension portion 152 extends toward an outer side of the first main body portion 151 along a radial direction RD. Further, the first coil 11 surrounds the periphery of the first main body portion 151, for example, the first coil 11 wraps around the first main body portion 151, and the first extension portion 152 is spaced apart from the magnet assembly 12 in an axial direction AD. An orthographic projection of the first main body portion 151 on a reference plane perpendicular to the axial direction AD does not overlap with an orthographic projection of the magnet assembly 12 on the same reference plane, an orthographic projection of the first extension portion 152 on the same reference plane overlaps with an orthographic projection of the magnet assembly 12 on the same reference plane, and a distance between the first main body portion 151 and the magnet assembly 12 in the radial direction RD is less than a distance between the first extension portion 152 and the magnet assembly 12 in the axial direction AD. In such cases, magnetic flux lines of a magnetic field generated by the magnet assembly 12 may be more concentrated, and more magnetic flux lines can pass through the first coil 11, i.e., the magnetic leakage is reduced, which is conducive to improving the sensitivity of the transducer device 10. It should be noted that: unlike the technical solution described in FIG. 2, a power for relative movement between the first coil 11 and the magnet assembly 12 in a technical solution described in FIG. 11 still originates from an Ampere force. Similarly, the first main body portion 151 may have a hollow structure, and the first main body portion 151 and the first extension portion 152 may both be made of a soft magnetic material.

In some embodiments, in conjunction with FIG. 12, the transducer device 10 includes one or more cushioning members 16 disposed on an inner side of the magnet assembly 12. The one or more cushioning members 16 are located on at least one side of the first coil 11 along the axial direction AD, for example, opposite sides of the first coil 11 along the axial direction AD are each disposed with a cushioning member 16. The cushioning member 16 may be secured to the magnet assembly 12, or may be secured to the first magnetic conductive member 15. Furthermore, the dimension of the cushioning member 16 in a radial direction RD is greater than the dimension of the first coil 11 in the radial direction RD, which is conducive to reducing the risk of magnetic adsorption between the first magnetic conductive member 15 and the magnet assembly 12, especially under extreme working conditions such as dropping. The cushioning member 16 may be made of foam. It should be noted that: in the embodiment in which the first magnetic conductive member 15 is configured to be fixed relative to the first coil 11, such as in any of the technical solutions described in FIG. 7 to FIG. 11, the cushioning member 16 may be adaptively provided according to actual needs.

Further, specific structures of the first coil 11 and the magnet assembly 12, and a relationship between the two are exemplarily described. For the convenience of description, a technical solution described in FIG. 9 is taken as a basic structure of the transducer device 10. Thus, when specific structures of the first coil 11 and the magnet assembly 12 and a relationship between the two are determined, specific structures of other structural components such as the first vibration transmission plate 13, the first frame 14, the first magnetic conductive member 15 and the cushioning member 16 in the transducer device 10 and a relationship thereof can be adapted according to actual needs, as described in detail in any of the embodiments described from FIG. 3 to FIG. 12, which will not be repeated here.

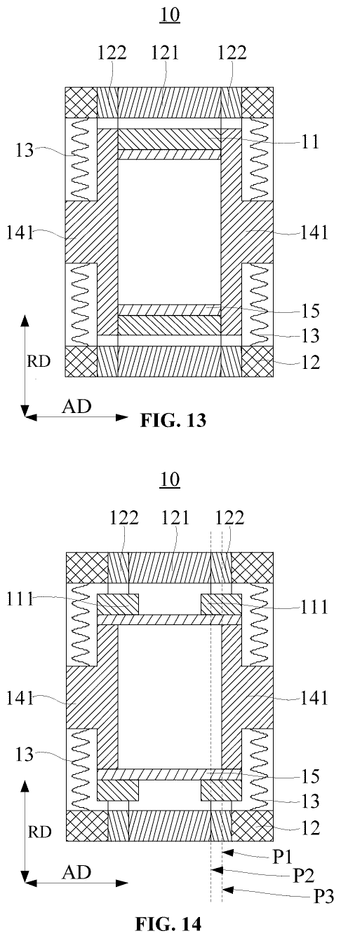

In some embodiments, in conjunction with FIG. 13, the magnet assembly 12 includes a hard magnet 121, and a count of the first coil 11 is only one, with the magnet assembly 12 and the first coil 11 at least partially overlapping in an axial direction AD, i.e., orthographic projections of the two are at least partially overlapping on a reference plane perpendicular to the radial direction RD. In a circumferential direction around the axial direction AD, the hard magnet 121 may either be a complete ring structure or may be composed of a plurality of arcuate blocks. In the axial direction AD, the hard magnet 121 may be spliced together by a plurality of oppositely polarized hard magnets. In such cases, since the magnetic field distribution of the hard magnet 121 in a three-dimensional space is not uniform, which results in a magnetic field intensity of a magnetic field formed by the magnet assembly 12 not equal everywhere, for example, the hard magnet 121 has a stronger magnetic field intensity at two ends along the axial direction AD compared to the middle, while a large portion of the first coil 11 corresponds precisely to the middle of the hard magnet 121, an average value of the magnetic field intensity B acting on the first coil 11 in the formula F∝BIL for calculating the Ampere force may be relatively small.

In some embodiments, in conjunction with FIG. 14, the magnet assembly 12 may include a hard magnet 121, and the first coil 11 may include two first sub-coils 111 spaced apart in the axial direction AD. The two first sub-coils 111 may be proximate to two ends of the hard magnet 121, respectively. A distance between a center dividing plane of one of the first sub-coils 111 (e.g., shown as P1 in FIG. 14) and an end surface of the hard magnet 121 (e.g., P2 in FIG. 14) in the axial direction AD may be less than or equal to half a dimension of the first sub-coil 111 in the axial direction AD. In some embodiments, the center dividing plane of the first sub-coil 111 (e.g., shown as P1 in FIG. 14) is coplanar with the end surface of the hard magnet 121 (e.g., P2 in FIG. 14) in the axial direction AD. In such cases, the two first sub-coils 111 may each be located at a position with a higher magnetic field intensity in the magnetic field formed by the magnet assembly 12, which is conducive to increasing the average value of the magnetic field intensity B, thereby increasing the sensitivity of the transducer device 10. It should be noted that: the center dividing plane of one of the first sub-coils 111 (e.g., shown as P1 in FIG. 14) refers to a plane on which half of the dimension of the first sub-coil 111 in the axial direction AD is located, or a plane on which half of a count of turns of the first sub-coil 111 is located, which will not be repeated hereafter.

In some embodiments, the two first sub-coils 111 may be connected in series with each other and wound in opposite directions. In such cases, Ampere forces generated by the two first sub-coils 111 may remain in the same direction. In some other embodiments, the two first sub-coils 111 may be connected in parallel with each other.

In some embodiments, the magnet assembly 12 includes two soft magnets 122, and the two soft magnets 122 are connected to two end surfaces of the hard magnet 121, respectively, so that magnetic flux lines of a magnetic field generated by the magnet assembly 12 are more concentrated and more magnetic flux lines can pass through the first coil 11, i.e., the magnetic leakage is reduced, which improves the sensitivity of the transducer device 10. A distance between a center dividing plane of one of the first sub-coils 111 (e.g., shown as P1 in FIG. 14) and a center dividing plane of one of the soft magnets 122 (e.g., shown as P3 in FIG. 14) in the axial direction AD may be less than or equal to half a dimension of the first sub-coil 111 in the axial direction AD. In some embodiments, the center dividing plane of the first sub-coil 111 (e.g., shown as P1 in FIG. 14) is co-planar with the center dividing plane of the soft magnet 122 (e.g., shown as P3 in FIG. 14) in the axial direction AD. In such cases, the two first sub-coils 111 can each be located at a position of higher magnetic field intensity in the magnetic field formed by the magnet assembly 12, which is conducive to increasing the average value of the magnetic field intensity B and thus increasing the sensitivity of the transducer device 10. It should be noted that: the center dividing plane of one of the soft magnets 122 (e.g., shown as P3 in FIG. 14) refers to a plane located at half the dimension of the soft magnet 122 in the axial direction AD, which will not be repeated further.

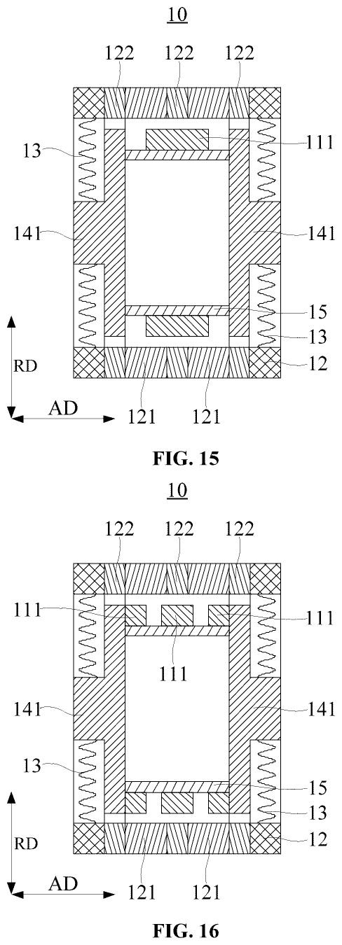

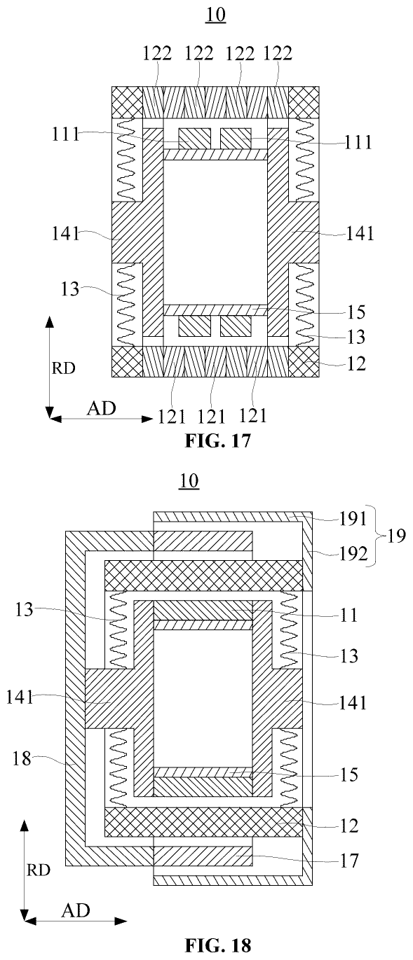

In some embodiments, in conjunction with FIG. 15 to FIG. 17, the magnet assembly 12 includes a plurality of hard magnets 121 arranged along an axial direction AD, such as two hard magnets 121 shown in FIG. 15 and FIG. 16, or three hard magnets 121 shown in FIG. 17. Any two adjacent hard magnets 121 in the plurality of hard magnets are opposite to each other with the same polarity, so that a magnetic field formed by the magnet assembly 12 has as high a magnetic field intensity as possible at an end of any one of the hard magnets 121. Based on this, the first coil 11 may include at least one first sub-coil 111, such as one first sub-coil 111 as shown in FIG. 15, three first sub-coils 111 as shown in FIG. 16, or two first sub-coils 111 shown in FIG. 17. At least one of all the first sub-coils 111 may overlap with two adjacent hard magnets 121 in the axial direction AD, i.e., the orthographic projection of the at least one of the first sub-coils 111 may overlap with orthographic projections of the two adjacent hard magnets 121 on a reference plane perpendicular to a radial direction RD. In such cases, the at least one first sub-coil 111 may be located at a position of higher magnetic field intensity in the magnetic field formed by the magnet assembly 12, which is favorable for increasing the average value of the magnetic field intensity B, and thus increasing the sensitivity of the transducer device 10.

Further, the magnet assembly 12 may include a plurality of soft magnets 122, and the plurality of soft magnets 122 and the plurality of hard magnets 121 may be arranged in an alternating manner in the axial direction AD, so that magnetic flux lines of the magnetic field generated by the magnet assembly 12 are more concentrated and more magnetic flux lines can pass through the first coil 11, i.e., the magnetic leakage is reduced, thereby improving the sensitivity of the transducer device 10.

In some embodiments, in conjunction with FIG. 15, the count of hard magnets 121 may be two, and the first coil 11 may comprise one first sub-coil 111, and the first sub-coil 111 may overlap with the two hard magnets 121 in the axial direction AD, i.e., an orthographic projection of the first sub-coil 111 may overlap with the orthographic projections of two adjacent hard magnets 121 on a reference plane perpendicular to the radial direction RD, so as to cause the first sub-coil 111 to be located at a position of higher magnetic field intensity in the magnetic field formed by the magnet assembly 12, which is favorable for increasing the average value of the magnetic field intensity B, thus increasing the sensitivity of the transducer device 10. Similar to the technical solution described in FIG. 14, in a technical solution described in FIG. 15, a distance between a center dividing plane of the first sub-coil 111 and a center dividing plane of one of the soft magnets 122 in the axial direction AD may be less than or equal to half a dimension of the first sub-coil 111 in the axial direction AD. In some embodiments, the center dividing plane of the first sub-coil 111 is coplanar with the center dividing plane of the soft magnet 122 in the axial direction AD. In such cases, the two first sub-coils 111 can each be located at a position of higher magnetic field intensity in the magnetic field formed by the magnet assembly 12, which is conducive to increasing an average value of the magnetic field intensity B, thus increasing the sensitivity of the transducer device 10. Furthermore, the first vibration transmission plate 13 may be made of a soft magnetic material, i.e., the first vibration transmission plate 13 may be magnetically conductive such that the magnetic flux lines of the magnetic field generated by the magnet assembly 12 are more concentrated and more magnetic flux lines can pass through the first coil 11, i.e., the magnetic leakage is reduced, thereby improving the sensitivity of the transducer device 10. Specifically, in conjunction with FIG. 35, under the same conditions, compared to a frequency response curve of a technical solution in which the first vibration transmission plate 13 is not magnetically conductive (e.g., shown as curve a C35_1 in FIG. 35), in the technical solution described in FIG. 15, since the first vibration transmission plate 13 is magnetically conductive, most parts of a corresponding frequency response curve (e.g., shown as a curve C35_2 in FIG. 35) are located above the curve C35_2, i.e., in the technical solution, the transducer device 10 has a higher sensitivity.

In some embodiments, in conjunction with FIG. 16 and FIG. 17, the magnet assembly 12 includes a plurality of hard magnets 121 arranged in an axial direction AD, the first coil 11 includes a plurality of first sub-coils 111, and a count of the first sub-coils 111 may not be equal to a count of the hard magnets 121. For example, as shown in FIG. 16, there may be two hard magnets 121 and three first sub-coils 111. As another example, as shown in FIG. 17, there may be three hard magnets 121 and two first sub-coils 111. At least one first sub-coil 111 may overlap with two adjacent hard magnets 121 in the axial direction AD, i.e., the orthographic projection of at least one first sub-coil 111 may overlap with orthographic projections of the two adjacent hard magnets 121 on a reference plane perpendicular to the radial direction RD, such that each of the first sub-coils 111 is located, as much as possible, at a position of higher magnetic field intensity in the magnetic field formed by the magnet assembly 12, which is conducive to improving the average value of the magnetic field intensity B, thereby increasing the sensitivity of the transducer device 10. Similar to the technical solution described in FIG. 14, in the technical solutions described in FIG. 16 and FIG. 17, a distance between a center dividing plane of a first sub-coil 111 and a center dividing plane of a soft magnet 122 in the axial direction AD may be less than or equal to half a dimension of the first sub-coil 111 in the axial direction AD. In some embodiments, the center dividing plane of the first sub-coil 111 is coplanar with the center dividing plane of the soft magnet 122 in the axial direction AD. In such cases, each of the first sub-coils 111 is located at, as much as possible, a position of higher magnetic field intensity in the magnetic field formed by the magnet assembly 12, which is conducive to increasing the average value of the magnetic field intensity B, thus increasing the sensitivity of the transducer device 10. Furthermore, the first vibration transmission plate 13 may be made of a soft magnetic material, so that the magnetic flux lines of the magnetic field generated by the magnet assembly 12 are more concentrated and more magnetic flux lines can pass through the first coil 11, i.e., the magnetic leakage is reduced, which is conducive to increasing the sensitivity of the transducer device 10. Further, the count of the first sub-coils 111 may be less than the count of the hard magnets 121, such as the three hard magnets 121 and two first sub-coils 111 as shown in FIG. 17, and any of the first sub-coils 111 may overlap with two adjacent hard magnets 121 in the axial direction AD, i.e., the orthographic projection of any one of the first sub-coils 111 may overlap with orthographic projections of the two adjacent hard magnets 121 on a reference plane perpendicular to the radial direction RD. The first vibration transmission plate 13 may be made of a soft magnetic material to make magnetic flux lines of the magnetic field generated by the magnet assembly 12 more concentrated and more magnetic flux lines pass through the first coil 11, i.e., the magnetic leakage is reduced, thereby increasing the sensitivity of the transducer device 10.

In some embodiments, the plurality of first sub-coils 111 may be connected in series with each other, and any two adjacent first sub-coils 111 are wound in opposite directions. In such cases, Ampere forces generated by the plurality of first sub-coils 111 may remain in the same direction. In some other embodiments, the plurality of first sub-coils 111 may also be connected in parallel with each other.

Generally, the smaller the resistance of the first coil 11, the smaller its voltage division. The transducer device 10 is connected to a corresponding power amplifier, and the output efficiency of the power amplifier is directly proportional to the size of the load to which it is connected (e.g., the resistance of the first coil 11). Based on this, if the dimension of the first coil 11 in the axial direction AD is increased, for example, if the first coil 11 is wound several more times, although the resistance of the first coil 11 can be increased, the average value of the magnetic field intensity B is also reduced. Accordingly, compared to the case where the count of the first coil 11 is only one or the first coil 11 includes one first sub-coil 111, setting the first coil 11 to include a plurality of first sub-coils 111 and each of the plurality of first sub-coil 111 to be located, as much as possible, at a position of higher magnetic field intensity in the magnetic field formed by the magnet assembly 12 not only increases the resistance of the first coil 11, which improves the output efficiency of the power amplifier, but also increases the average value of the magnetic field intensity B, thereby improving the sensitivity of the transducer device 10.

In some embodiments, in conjunction with FIG. 18 to FIG. 21, the transducer device 10 includes a second coil 17 surrounding a periphery of the magnet assembly 12. The second coil 17 is spaced apart from the magnet assembly 12 in a radial direction RD and at least partially overlaps with the magnet assembly 12 in an axial direction AD, i.e., an orthographic projection of the second coil 17 on a reference plane perpendicular to the radial direction RD at least partially overlaps with an orthographic projection of the magnet assembly 12 on the reference plane. Based on this, in an operation state in which the transducer device 10 is input with a second excitation signal, the energized second coil 17 generates a second Ampere force that causes the second coil 17 to move relative to the magnet assembly 12 in a magnetic field formed by the magnet assembly 12, thereby converting the second excitation signal into a corresponding mechanical vibration. In such cases, not only a magnetic field inside the magnet assembly 12 is utilized by the first coil 11, but also a magnetic field outside the magnet assembly 12 is utilized by the second coil 17, which leads to higher utilization of the magnetic field of the magnet assembly 12. It should be noted that: in technical solutions described in FIG. 18 to FIG. 21, the first coil 11, the magnet assembly 12, the first vibration transmission plate 13, the first frame 14, the first magnetic conductive member 15, and the cushioning member 16 and their relationship can be adjusted according to actual needs, as described in detail in any of the embodiments described in FIG. 1 to FIG. 17, and will not be repeated herein. For the convenience of description, the technical solution described in FIG. 8 or FIG. 9 is taken as a basic structure of the transducer device 10.

In some embodiments, the first excitation signal and the second excitation signal may be the same, for example, the second coil 17 and the first coil 11 are connected in series with each other so that the second Ampere force and the first Ampere force can be in the same direction, which is conducive to increasing the sensitivity the transducer device 10. Since the direction of the magnetic field inside the magnet assembly 12 and the direction of the magnetic field outside the magnet assembly 12 can be simply regarded as opposite when the second coil 17 and the first coil 11 are connected in series with each other, the second coil 17 and the first coil 11 may be wound in an opposite direction subsequently. In some other embodiments, the second coil 17 and the first coil 11 may also be connected in parallel with each other.

In some embodiments, the first excitation signal and the second excitation signal are different, which is conducive to broadening application scenarios of the transducer device 10, such as application scenarios of AR/VR. Specifically, one of the first coils 11 and the second coil 17 is input with an excitation signal such as a video signal or a music signal, so as to facilitate a user to enjoy an auditory feast, and the other is input with an excitation signal, such as vibration feedback so as to enhance a tactile experience or remind the user that other information is involved when the user is enjoying the auditory feast.

In some embodiments, the second coil 17 is configured to be fixed relative to the first coil 11, for example, the transducer device 10 includes a second frame 18 connecting the first coil 11 and the second coil 17. The second coil 17 may be connected to the second frame 18 via a medium such as glue, the first coil 11 may be connected to the first frame 14 via a medium such as glue, and the first frame 14 may be connected to the second frame 18 through, for example, a plug-in connection.

In some embodiments, the transducer device 10 includes a second magnetic conductive member 19, with at least a portion of the second magnetic conductive member 19 surrounding the periphery of the second coil 17 and at least partially overlapping with the magnet assembly 12 in the axial direction AD, i.e., an orthographic projection of the second magnetic conductive member 19 on a reference plane perpendicular to the radial direction RD at least partially overlaps with the orthographic projection of the magnet assembly 12 on the reference plane, so that magnetic flux lines of the magnetic field generated by the magnet assembly 12 are more concentrated and more magnetic flux lines can pass through the second coil 17, i.e., the magnetic leakage is reduced, which is conducive to improving the sensitivity of the transducer device 10. In addition, since the direction of the magnetic field inside the magnet assembly 12 and the direction of the magnetic field outside the magnet assembly 12 can simply be regarded as opposite such that directions of currents inside the first coil 11 and the second coil 17 can be consequently opposite, a first inductance generated by the energized first coil 11 on the first magnetic conductive member 15 may be at least partially offset by a second inductance generated by the energized second coil 17 on the first magnetic conductive member 15, so that a total inductance can be reduced, which is conducive to improving the acoustic performance of the transducer device 10 in a high-frequency band.

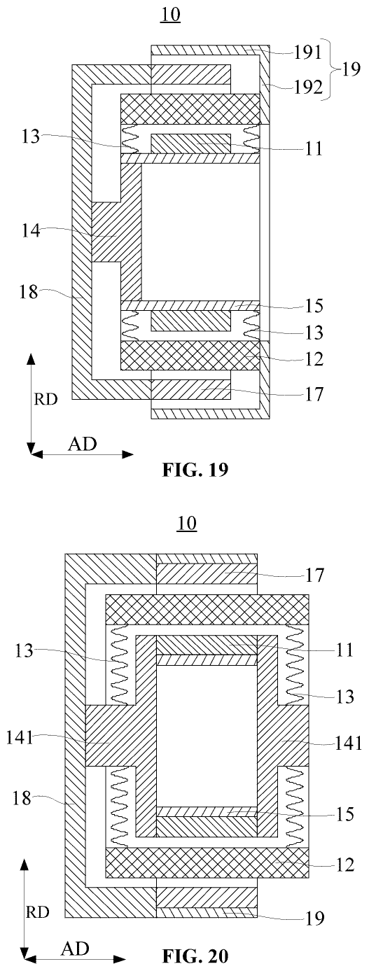

In some embodiments, in conjunction with FIG. 18 and FIG. 19, the second magnetic conductive member 19 is configured to be fixed relative to the magnet assembly 12, with at least a portion of the second magnetic conductive member 19 spaced apart from the second coil 17 in the radial direction RD. In such cases, the second magnetic conductive member 19 may move relative to the second coil 17 following the magnet assembly, which is conducive to improving the sensitivity of the transducer device 10.

In some embodiments, the second magnetic conductive member 19 includes a second main body portion 191 and a second extension portion 192 connected to the second main body portion 191. The second main body portion 191 has a hollow structure, the second extension portion 192 extends along the radial direction RD toward an inner side of the second main body portion 191, and the second main body portion 191 surrounds the periphery of the second coil 17 and is spaced apart from the second coil 17 in the radial direction RD. The second extension portion 192 is connected to the magnet assembly 12 and is spaced apart from the second coil 17 in the axial direction AD. The second magnetic conductive member 19 may be entirely magnetically conductive, for example, the second main body portion 191 and the second extension portion 192 are made of a soft magnetic material. The second magnetic conductive member 19 may be partially magnetically conductive. For example, the second main body portion 191 and the second extension portion 192 are made of a soft magnetic material and a plastic material, respectively. Furthermore, the second main body portion 191 and the second extension portion 192 may be an integrally-molded structural component.

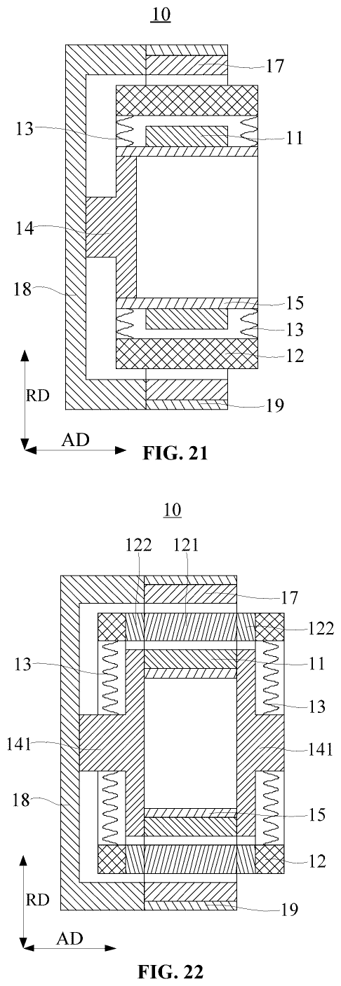

In some embodiments, in conjunction with FIG. 20 and FIG. 21, the second magnetic conductive member 19 is configured to be fixed relative to the second coil 17. In such cases, the second magnetic conductive member 19 may move relative to the magnet assembly 12 following the second coil 17, which not only simplifies the structure of the second magnetic conductive member 19, but also further alleviates (or even eliminates) the sound leakage of the transducer device 10 due to the acoustic cavity effect.

In some embodiments, a distance between the second coil 17 and the second magnetic conductive member 19 in the radial direction RD may be less than the distance between the second coil 17 and the magnet assembly 12 in the radial direction RD, for example, the second coil 17 is secured to an inner wall of the second magnetic conductive member 19. In such cases, compared to technical solutions described in FIG. 18 and FIG. 20, in the technical solutions described in FIG. 20 and FIG. 21, a magnetic gap between the second magnetic conductive member 19 and the magnet assembly 12 in the radial direction RD is smaller, which is conducive to improving the sensitivity of the transducer device 10.

In some embodiments, at least a portion of the second magnetic conductive member 19 is made of a hard magnetic material, for example, the second magnetic conductive member 19 includes a hard magnet and a soft magnet stacked along the axial direction AD.

Further, specific structures of the second coil 17 and the magnet assembly 12, and their relationship are exemplarily described. For the convenience of description, the technical solution described in FIG. 20 is taken as a basic structure of the transducer device 10. Thus, when the specific structures of the second coil 17 and the magnet assembly 12 and the relationship between the two are determined, specific structures of other components of the transducer device 10 such as the first coil 11, the magnet assembly 12, the first vibration transmission plate 13, the first frame 14, the first magnetic conductive member 15 and the cushioning member 16 and a relationship thereof can be adjusted according to actual needs, as described in detail in any of the embodiments from FIG. 1 to FIG. 17, and will not be repeated herein.

In some embodiments, in conjunction with FIG. 22, the magnet assembly 12 includes a hard magnet 121, and a count of the second coil 17 may also be only one. The hard magnet 121 and the second coil 17 at least partially overlap in the axial direction AD, i.e., orthographic projections of the hard magnet 121 and the second coil 17 on a reference plane perpendicular to the radial direction RD at least partially overlap. In a circumferential direction around the axial direction AD, the hard magnet 121 may either be a complete ring structure or may be composed of a plurality of arcuate blocks. In the axial direction AD, the hard magnet 121 may be spliced together by a plurality of oppositely polarized hard magnets. In such cases, since the magnetic field distribution of the hard magnet 121 in a three-dimensional space is not uniform, which results in the magnetic field intensity of the magnetic field formed by the magnet assembly 12 not equal everywhere, for example, two ends of the hard magnet 121 have a higher magnetic field intensity in the axial direction AD compared to the middle, while a larger portion of the second coil 17 corresponds exactly to the middle of the hard magnet 121, an average value of the magnetic field intensity B acting on the second coil 17 in a formula F∝BIL for calculating the Ampere force may be relatively small.

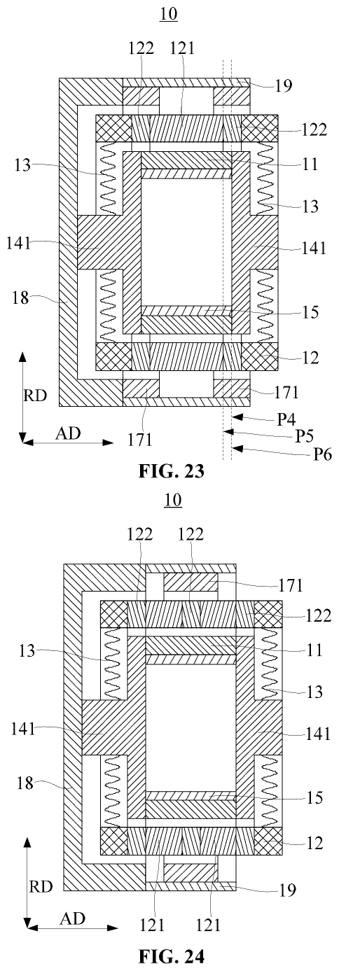

In some embodiments, in conjunction with FIG. 23, the magnet assembly 12 includes a hard magnet 121, the second coil 17 includes two second sub-coils 171 spaced apart in the axial direction AD, and the two second sub-coils 171 may be close to two ends of the hard magnet 121, respectively. A distance between a center dividing plane of a second sub-coil 171 (e.g., shown at P4 in FIG. 23) and an end surface of the hard magnet 121 (e.g., shown at P5 in FIG. 23) in the axial direction AD may be less than or equal to half a dimension of the second sub-coil 171 in the axial direction AD. In some embodiments, the center dividing plane of the second sub-coil 171 (e.g., shown at P4 in FIG. 23) is coplanar with the end surface of the hard magnet 121 (e.g., P5 in FIG. 23) in the axial direction AD. In such cases, the two second sub-coils 171 may each be located at a position of higher magnetic field intensity in the magnetic field formed by the magnet assembly 12, which is favorable for increasing the average value of the magnetic field intensity B, thereby increasing the sensitivity of the transducer device 10. It should be noted that: the center dividing plane of the second sub-coil 171 (shown as P4 in FIG. 23) refers to a plane in which half of the dimension of the second sub-coil 171 in the axial direction AD is located, or a plane in which half of a count of turns of the second sub-coil 171 is located, which will not be repeated hereafter.

In some embodiments, the two second sub-coils 171 may be connected in series with each other and wound in opposite directions. In such cases, Ampere forces generated by the two second sub-coils 171 may remain in the same direction. In some other embodiments, the two second sub-coils 171 are connected in parallel with each other.

In some embodiments, the magnet assembly 12 includes two soft magnets 122, and the two soft magnets 122 are connected to two end surfaces of the hard magnet 121, respectively, so that magnetic flux lines of the magnetic field generated by the magnet assembly 12 are more concentrated and more magnetic flux lines can pass through the first coil 11, i.e., the magnetic leakage is reduced, which is conducive to improving the sensitivity of the transducer device 10. A distance between the center dividing plane of a second sub-coil 171 (e.g., shown at P4 in FIG. 23) and a center dividing plane of one of the two soft magnets 122 (e.g., shown at P6 in FIG. 23) in the axial direction AD may be less than or equal to half the dimension of the second sub-coil 171 in the axial direction AD. In some embodiments, the center dividing plane of the second sub-coil 171 (e.g., shown at P4 in FIG. 23) is coplanar with the center dividing plane of the soft magnet 122 (e.g., shown at P6 in FIG. 23) in the axial direction AD. In such cases, the two second sub-coils 171 can each be located at a position of higher magnetic field intensity in the magnetic field formed by the magnet assembly 12, which is conducive to increasing the average value of the magnetic field intensity B, thus increasing the sensitivity of the transducer device 10. It should be noted that: the center dividing plane of the soft magnet 122 (e.g., shown at P6 in FIG. 23) refers to a plane where half of the dimension of the soft magnet 122 in the axial direction AD is located, which will not be repeated hereafter.

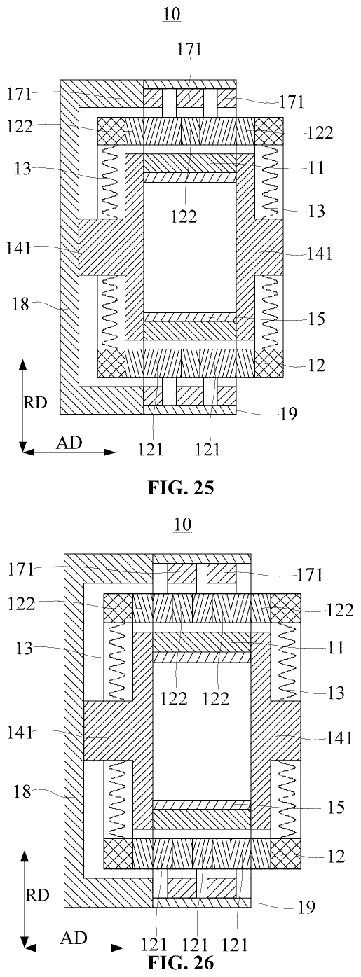

In some embodiments, in conjunction with FIG. 24 to FIG. 26, the magnet assembly 12 includes a plurality of hard magnets 121 arranged in the axial direction AD, such as two hard magnets 121 shown in FIG. 24 and FIG. 25, or three hard magnets 121 shown in FIG. 26, with any two adjacent hard magnets 121 opposite to each other with the same polarity so that the magnetic field formed by the magnet assembly 12 has as high a magnetic field intensity as possible at ends of any one of the hard magnets 121. Based on this, the second coil 17 includes at least one second sub-coil 171, such as one second sub-coil 171 shown in FIG. 24, three second sub-coils 171 as shown in FIG. 25, or two second sub-coils 171 as shown in FIG. 26. At least one of the second sub-coils 171 may overlap with two adjacent hard magnets 121 in the axial direction AD, i.e., an orthographic projection of at least one of the second sub-coils 171 on a reference plane perpendicular to a radial direction RD may overlap with orthographic projections of the two adjacent hard magnets 121 on the reference plane. In such cases, the second sub-coils 171 may be located at positions of higher magnetic field intensity in the magnetic field formed by the magnet assembly 12, which is conducive to increasing the average value of the magnetic field intensity B, thus increasing the sensitivity of the transducer device 10.

Further, the magnet assembly 12 may include a plurality of soft magnets 122, and the plurality of soft magnets 122 and the plurality of hard magnets 121 may be arranged in an alternating manner in the axial direction AD, so that the magnetic flux lines of the magnetic field generated by the magnet assembly 12 are more concentrated and more magnetic flux lines can pass through the second coil 17, i.e., the magnetic leakage is reduced, which is conducive to improving the sensitivity of the transducer device 10.

In some embodiments, in conjunction with FIG. 24, a count of the hard magnets 121 is two. The second coil 17 includes one second sub-coil 171, and the second sub-coil 171 may overlap with two adjacent hard magnets 121 in the axial direction AD, i.e., an orthographic projection of the second sub-coil 171 on a reference plane perpendicular to a radial direction AD overlaps with orthographic projections of two adjacent hard magnets 121 on the reference plane, so as to enable the second sub-coil 171 to be located at a position of higher magnetic field intensity in the magnetic field formed by the magnet assembly 12, which is conducive to increasing the average value of the magnetic field intensity B, thus increasing the sensitivity of the transducer device 10. Similar to the technical solution described in FIG. 23, in the technical solution described in FIG. 24, a distance between a center dividing plane of the second sub-coil 171 and a center dividing plane of the soft magnet 122 may be less than or equal to half a dimension of the second sub-coil 171 in the axial direction AD. In some embodiments, the center dividing plane of the second sub-coil 171 is coplanar with the center dividing plane of the soft magnet 122 in the axial direction AD. In such cases, the second sub-coil 171 can be located at a position of higher magnetic field intensity in the magnetic field formed by the magnet assembly 12, which is conducive to increasing the average value of the magnetic field intensity B, thus increasing the sensitivity of the transducer device 10.

In some embodiments, in conjunction with FIG. 25 and FIG. 26, the magnet assembly 12 includes a plurality of hard magnets 121 arranged in the axial direction AD, the second coil 17 includes a plurality of second sub-coils 171, and a count of the second sub-coils 171 is not equal to a count of the hard magnets 121. For example, there are two hard magnets 121 and three second sub-coils 171 as shown in FIG. 25. As another example, there are three hard magnets 121 and two second sub-coils 171 as shown in FIG. 26. At least one of the second sub-coils 171 may overlap with two adjacent hard magnets 121 in the axial direction AD, i.e., an orthographic projection of at least one of the second sub-coils 171 on a reference plane perpendicular to a radial direction RD may overlap with orthographic projections of the two adjacent hard magnets 121 on the reference plane, such that each of the second sub-coils 171 is located, as much as possible, at a position of higher magnetic field intensity in the magnetic field formed by the magnet assembly 12, which is conducive to increasing the average value of the magnetic field intensity B, thereby increasing the sensitivity of the transducer device 10. Similar to the technical solution described in FIG. 23, in the technical solution described in FIG. 25 and FIG. 26, a distance between a center dividing plane of s second sub-coil 171 and a center dividing plane of s soft magnet 122 in the axial direction AD may be less than or equal to half a dimension of the second sub-coil 171 in the axial direction AD. In some implementations, the center dividing plane of the second sub-coil 171 is coplanar with the center dividing plane of the soft magnet 122 in the axial direction AD. In such cases, each of the second sub-coils 171 is located, as much as possible, at a position of higher magnetic field intensity in the magnetic field formed by the magnet assembly 12, which is conducive to increasing the average value of the magnetic field intensity B, thus increasing the sensitivity of the transducer device 10.

In some implementations, the plurality of second sub-coils 171 may be connected in series with each other, and any two adjacent second sub-coils 171 are wound in opposite directions. In such cases, Ampere forces generated by each of the plurality of second sub-coils 171 may remain in the same direction. In some other embodiments, two second sub-coils 171 may be connected in parallel with each other.

Generally, the lower the resistance of the second coil 17, the lower the voltage division of the second coil 17. The transducer device 10 may be connected to a corresponding power amplifier, and the output efficiency of the power amplifier is directly proportional to the size of the load to which it is connected (e.g., the resistance of the second coil 17). Based on this, if the dimension of the second coil 17 in the axial direction AD is increased, for example, if the second coil 17 is wound more times, although the resistance of the second coil 17 can increase, the average value of the magnetic field intensity B is reduced. Thus, compared to the case where the count of the second coil 17 is only one or the second coil 17 includes one second sub-coil 171, setting the second coil 17 to include a plurality of second sub-coils 171, with each of the second sub-coil 171 located, as much as possible, at a position of higher magnetic field intensity in the magnetic field formed by the magnet assembly 12 not only increases the resistance of the second coil 17, which improves the output efficiency of the power amplifier, but also increases the average value of the magnetic field intensity B, which improves the sensitivity of the transducer device 10.

In conjunction with FIG. 13 to FIG. 17 and FIG. 22 to FIG. 26, when a specific structure of the magnet assembly 12 is determined, specific structures of the first coil 11 and the second coil 17 may be the same or similar. For example, the magnet assembly 12 includes a hard magnet 121, and the first coil 11 and the second coil 17 include two first sub-coils 111 and two second sub-coils 171 spaced apart in the axial direction AD, respectively. As another example, the magnet assembly 12 includes two hard magnets 121, the first coil 11 and the second coil 17 include a first sub-coil 111 and a second sub-coil 171, respectively, with the first sub-coil 111 and the second sub-coil 171 overlapping with the two hard magnets 121 in the axial direction AD, respectively, i.e., an orthographic projection of the first sub-coil 111 and an orthographic projection of the second sub-coil 171 on a reference plane perpendicular to a radial direction RD overlap with orthographic projections of the two hard magnets 121 on the reference plane, respectively. As another example, the magnet assembly 12 includes a plurality of hard magnets 121 arranged in the axial direction AD, and the first coil 11 and the second coil 17 include a plurality of first sub-coils 111 and a plurality of second sub-coils, respectively. A count of the first sub-coils 111 and a count of the second sub-coils 171 are not equal to a count of the hard magnets 121, respectively, and the count of the first sub-coils 111 is equal to the count of the second sub-coils 171. For example, there are two hard magnets 121, three first sub-coils 111, and three second sub-coils 17. As another example, there are three hard magnets 121, two first sub-coils 111, and two second sub-coils 171.

Based on the relevant descriptions above, the mechanical vibration generated by the transducer device 10 may be transmitted to the user either through bone conduction or through a combination of bone conduction and air conduction, as well as through air conduction. In general, air conduction requires an additional vibration diaphragm structure compared to bone conduction. For ease of description, the mechanical vibration generated by the transducer device 10 is exemplarily illustrated below as an example of a mechanical vibration transmitted to a user through bone conduction.

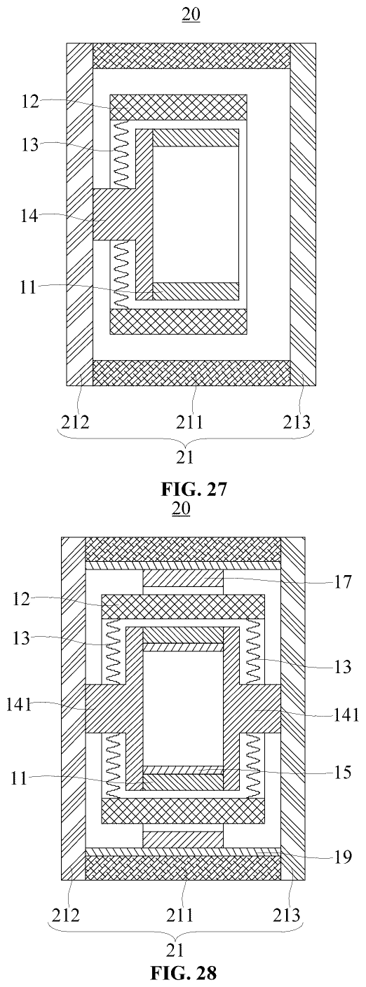

For example, in conjunction with FIG. 27 to FIG. 32, a core module 20 includes a core housing 21 and a transducer device 10, the transducer device 10 is provided in an accommodation cavity of the core housing 21. A specific structure of the transducer device 10 is described in detail in the relevant description of any of the embodiments in FIG. 1 to FIG. 26, and will not be repeated herein. Furthermore, for the convenience of description, the technical solution described in FIG. 3 is taken as a basic structure of the transducer device 10.

In some embodiments, in conjunction with FIG. 27, the core housing 21 includes a cylindrical side wall 211, and a first end wall 212 and a second end wall 213 connected to two ends of the cylindrical side wall 211, respectively. The transducer device 10 is located between the first end wall 212 and the second end wall 213, and connected to one of the first end wall 212 and the second end wall 213. For example, in any of the embodiments in FIG. 3 to FIG. 17, the first frame 14 is connected to the first end wall 212, or in any of the embodiments in FIG. 18 to FIG. 26, the second frame 18 is connected to the first end wall 212. In such cases, a mechanical vibration generated by the transducer device 10 may be transmitted to a user through one of the first end wall 212 and the second end wall 213 that is used to contact or abut the skin of the user. In some other embodiments, the first coil 11 is directly connected to one of the first end wall 212 and the second end wall 213, and the magnet assembly 12 is connected to the core housing 21 through the first vibration transmission plate 13.

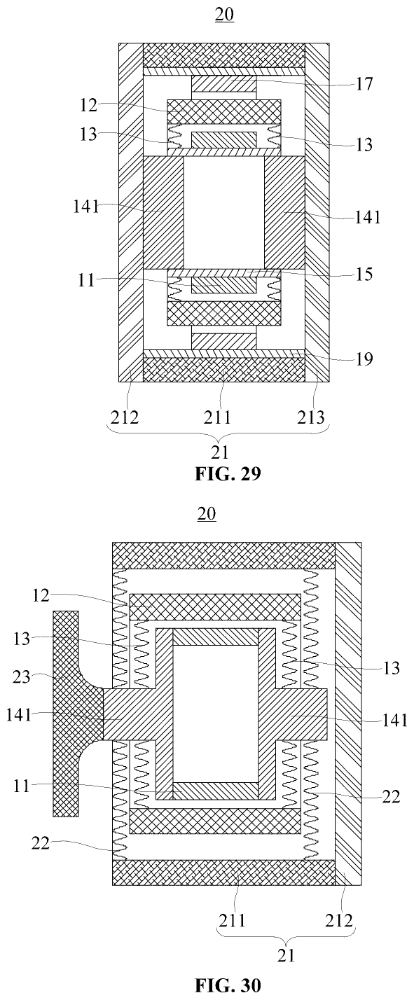

In some embodiments, in conjunction with FIG. 28 and FIG. 29, the transducer device 10 includes the first coil 11, the magnet assembly 12, the first vibration transmission plate 13, the first frame 14, and the second coil 17. The magnet assembly 12 surrounds the periphery of the first coil 11, the second coil 17 surrounds the periphery of the magnet assembly 12, the first coil 11 is connected to the first frame 14, and the first frame 14 is connected to the magnet assembly 12 through the first vibration transmission plate 13. The first frame 14 includes two first end caps 141 spaced apart in the axial direction AD, one of the first end caps 141 is connected to the first end wall 212, the other first end cap 141 is connected to the second end wall 213, and the second coil 17 is fixed relative to the core housing 21. In such cases, the mechanical vibration generated by the transducer device 10 may be transmitted to the user through one of the first end wall 212 and the second end wall 213 that is used to contact or abut the skin of the user.

In some embodiments, in conjunction with FIG. 30 to FIG. 32, the core module 20 includes a second vibration transmission plate 22 and a vibration panel 23. The transducer device 10 is suspended in an accommodation cavity of the core housing 21 through the second vibration transmission plate 22, and the vibration panel 23 is connected to the transducer device 10. The vibration panel 23 is connected to the first frame 14 in any of the embodiments of FIG. 3 to FIG. 17, or the vibration panel 23 is connected to the second frame 18 in any of the embodiments of FIG. 18 to FIG. 26. In such cases, the mechanical vibration generated by the transducer device 10 may be transmitted to the user via the vibration panel 23. Furthermore, a specific structure of the second vibration transmission plate 22 can be the same or similar to that of the first vibration transmission plate 13, and will not be repeated herein. An edge region of the second vibration transmission plate 22 is connected to the core housing 21, a center region of the second vibration transmission plate 22 is connected to a center region of the first frame 14, or a center region of the second vibration transmission plate 22 is connected to an edge region of the first frame 14 or the first magnetic conductive member 15. It should be noted that: compared with the technical solution described in FIG. 27, in the present technical solution, the transducer device 10 is suspended in the accommodation cavity of the core housing 21 through the second vibration transmission plate 22 such that the mechanical vibration generated by the transducer device 10 cam be less transmitted to the core housing 21, which is conducive to reducing the sound leakage of the core module 20.

In some embodiments, there are two second vibration transmission plates 22 located on opposite sides of the transducer device 10 in the axial direction AD. In such cases, the transducer device 10 is suspended in the core housing 21 through the two second vibration transmission plates 22 spaced apart from each other, which is conducive to lowering the risk of shaking of the transducer device 10 during operation, and making the core module 20 work more smoothly.

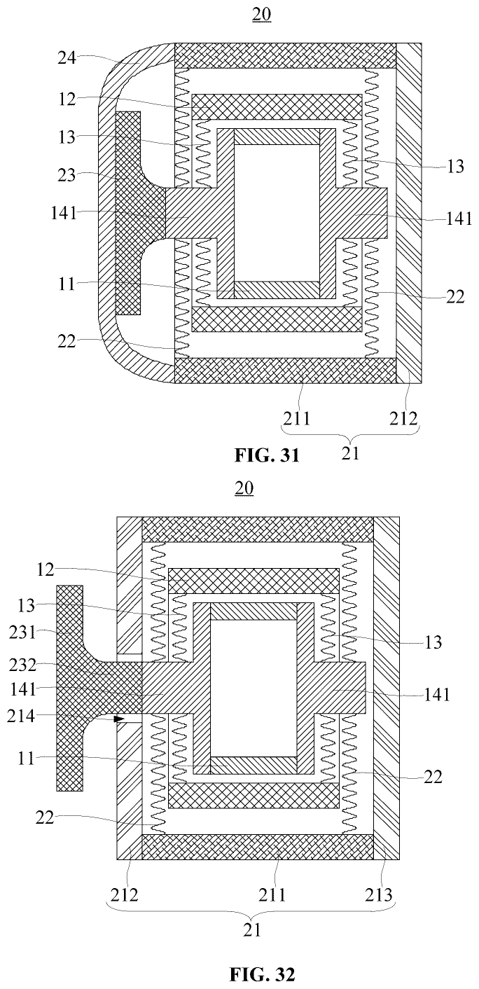

In some embodiments, in conjunction with FIG. 31, the core housing 21 includes the cylindrical side wall 211 and an end wall (e.g., the first end wall 212), the first end wall 212 being connected to one end of the cylindrical side wall 211 to allow the other end of the cylindrical side wall 211 to be open. The core module 20 includes a resilient cladding layer 24 connected to the vibration panel 23. For example, the resilient cladding layer 24 covers the vibration panel 23 and is connected to the other end of the cylindrical side wall 211. Further, the hardness of the resilient cladding layer 24 may be less than the hardness of the vibration panel 23. In such cases, an open end of the core housing 21 is covered by the resilient cladding layer 24, which is conducive to increasing the waterproof and dustproof performance of the core module 20, as well as to preventing the transducer device 10 from falling out of the core housing 21 under extreme working conditions, such as a falling, and increasing the appearance of the core module 20.

In some embodiments, in conjunction with FIG. 32, the core housing 21 includes the cylindrical side wall 211, and the first end wall 212 and the second end wall 213 are connected to two ends of the cylindrical side wall 211, respectively. The transducer device 10 is located between the first end wall 212 and the second end wall 213. The first end wall 212 is provided with a mounting hole 214. Further, the transducer device 10 is located between the first end wall 212 and the second end wall 213, The vibration panel 23 includes a main body portion 231 and a connection portion 232 connected to the main body portion 231, the main body portion 231 is disposed outside the core housing 21, and the connection portion 232 extends into the core housing 21 via the mounting hole 214 and is connected to the transducer device 10. When viewed along the axial direction AD, the area of the main body portion 231 is larger than the area of the mounting hole 214, and the area of the mounting hole 214 is larger than the area of the connection portion 232. In such cases, even though the mechanical vibration generated by the transducer device 10 is transmitted to the core housing 21 through the second vibration transmission plate 22, the phases of the sound leakages generated by the first end wall 212 and the second end wall 213, which vibrate respectively with the transducer device 10, are opposite. As a result, the sound leakages can cancel each other out in a far field, i.e., the core housing 21 itself, based on the principle of a sound dipole, can reduce the sound leakage of the core module 20. Therefore, there can be fewer or even no sound leakage reduction holes on the core housing 21, which is conducive to improving the waterproof and dustproof performance of the core module 20. For example, the accommodation cavity of the core housing 21 communicates with the exterior of the core module 20 through one single channel, the channel being a gap between the connection portion 232 and a wall of the mounting hole 214.

For example, in conjunction with FIG. 33, an electronic device 30 includes a support assembly 31 and the core module 20, the support assembly 31 is connected to the core housing 21 and used to support the core module 20 to place the core module 20 at a wearing position. A specific structure of the core module 20 is described in detail in connection with any of the embodiments from FIG. 27 to FIG. 32, and will not be repeated herein. Further, the support assembly 31 may be disposed in a ring shape and wrapped around the user's ear, as shown in (a) in FIG. 33; the support assembly 31 may be disposed in a structure in which an ear hook and a rear hook cooperate to be hung on the user's ear and wrapped around the rear side of the head, as shown in (b) in FIG. 33; or the support assembly 31 may be disposed in a head-beam structure and wrapped around the top of the user's head, as shown in (c) in FIG. 33. Correspondingly, the wearing position may be the front side of the user's ear that is away from the head, or a position on the user's cheek and close to the ear. Thus, the electronic device 30 may include a terminal device with an audio playback function, such as an earphone, smart glasses, or the like.

In some implementations, the electronic device 30 includes a housing connected to the support assembly 31, and the core module 20 is assembled as a module within the housing. In such cases, regardless of how the basic structure of the electronic device 30 is changed, the core module 20, as a key component, can be assembled, debugged, and subjected to other operations as a module, which is conducive to increasing the versatility of the core module 20, and reducing the manufacturing cost of the electronic device 30.

The foregoing is only a part of the embodiments of the present disclosure, and is not intended to limit the scope of protection of the present disclosure, and any equivalent device or equivalent process transformations utilizing the contents of the present disclosure and the accompanying drawings, or directly or indirectly applying them in other related fields of technology are similarly included in the scope of patent protection of the present disclosure.

What is claimed is:

1. A transducer device, comprising a first coil, a magnet assembly, and at least one first vibration transmission plate connecting the first coil and the magnet assembly, wherein
the magnet assembly surrounds a periphery of the first coil, the magnet assembly and the first coil are spaced apart in a radial direction of the transducer device and at least partially overlap with each other in an axial direction of the transducer device, and
in an operation state in which the transducer device is input with a first excitation signal, the first coil is energized and generates a first Ampere force in a magnetic field formed by the magnet assembly, and the first Ampere force causes the first coil to move relative to the magnet assembly.

2. The transducer device of claim 1, wherein the transducer device includes a first magnetic conductive member, the first coil surrounds a periphery of the first magnetic conductive member, and the first magnetic conductive member and the magnet assembly at least partially overlap with each other in the axial direction of the transducer device.

3. The transducer device of claim 2, wherein a ratio between a dimension of the first magnetic conductive member in the axial direction to a dimension of the first coil in the axial direction is greater than or equal to 1.

4. The transducer device of claim 2, wherein the first magnetic conductive member has a hollow structure.

5. The transducer device of claim 4, wherein a ratio between a dimension of the first magnetic conductive member in the radial direction to a dimension of the first coil in the radial direction is within a range of 0.5 to 1.5.

6. The transducer device of claim 2, wherein the first magnetic conductive member is configured to be fixed relative to the magnet assembly, and at least a portion of the first magnetic conductive member is spaced from the first coil in the radial direction.

7. The transducer device of claim 2, wherein the first magnetic conductive member is configured to be fixed relative to the first coil, and an orthographic projection of the first magnetic conductive member on a reference plane perpendicular to the axial direction does not overlap with an orthographic projection of the magnet assembly on the reference plane.

8. The transducer device of claim 7, wherein
an orthographic projection of the first coil on a reference plane perpendicular to the radial direction, an orthographic projection of the magnet assembly on the reference plane perpendicular to the radial direction, and an orthographic projection of the first magnetic conductive member on the reference plane perpendicular to the radial direction at least partially overlap, and
a distance between an overlapping region of the first magnetic conductive member and an overlapping region of the magnet assembly in the radial direction is less than or equal to 1.5 times a minimum distance between the first magnetic conductive member and the magnet assembly.

9. The transducer device of claim 7, wherein a distance between the first coil and the first magnetic conductive member in the radial direction is less than a distance between the first coil and the magnet assembly in the radial direction.

10. The transducer device of claim 7, wherein
the at least one first vibration transmission plate includes an inner ring fixation portion and an outer ring fixation portion nested with each other, and a plurality of spoke portions connecting the inner ring fixation portion and the outer ring fixation portion, and
the outer ring fixation portion is connected to the magnet assembly, and the inner ring fixation portion is connected to the first magnetic conductive member.

11. The transducer device of claim 7, wherein
the at least one first vibration transmission plate includes an inner ring fixation portion and an outer ring fixation portion nested with each other, and a plurality of spokes connecting the inner ring fixation portion and the outer ring fixation portion,
the outer ring fixation portion is connected to the magnet assembly,
the transducer device comprises a frame connected to the first magnetic conductive member, the inner ring fixation portion is connected to a center region of the frame, or the inner ring fixation portion is connected to an edge region of the frame.

12. The transducer device of claim 7, wherein the at least one first vibration transmission plate includes two first vibration transmission plates, and the two first vibration transmission plates are located on opposite sides of the first coil in the axial direction, respectively.

13. The transducer device of claim 2, wherein
the first magnetic conductive member is configured to be fixed relative to the first coil,
the first magnetic conductive member includes a first main body portion and a first extension portion connected to the first main body portion,
the first coil surrounds a periphery of the first main body portion, the first extension portion is spaced apart from the magnet assembly in the axial direction,
an orthographic projection of the first main body portion on a reference plane perpendicular to the axial direction does not overlap with an orthographic projection of the magnet assembly on the reference plane,
an orthographic projection of the first extension portion on the reference plane overlaps with the orthographic projection of the magnet assembly on the reference plane, and
a distance between the first main body portion and the magnet assembly in the radial direction is less than a distance between the first extension portion and the magnet assembly in the axial direction.

14. The transducer device of claim 1, wherein
the magnet assembly includes a hard magnet,
the first coil includes two first sub-coils spaced apart in the axial direction, and
a distance between a center dividing plane of one of the two first sub-coils and an end surface of the hard magnet in the axial direction is less than or equal to half a dimension of the one first sub-coil in the axial direction.

15. The transducer device of claim 14, wherein the two first sub-coils are connected in series with each other and wound in opposite directions.

16. The transducer device of claim 14, wherein
the magnet assembly includes two soft magnets,
the two soft magnets are connected to two end surfaces of the hard magnet, respectively, and
a distance between the center dividing plane of one of the two first sub-coils and a center dividing plane of one of the two soft magnets in the axial direction is less than or equal to half the dimension of the first sub-coil in the axial direction.

17. The transducer device of claim 1, wherein
the magnet assembly includes a plurality of hard magnets arranged along the axial direction, any two adjacent hard magnets in the plurality of hard magnets are opposite to each other with the same polarity, and
the first coil includes at least one first sub-coil, and at least one of the at least one first sub-coil overlaps with two adjacent hard magnets in the axial direction.

18. The transducer device of claim 17, wherein the plurality of hard magnets include two hard magnets, the first coil includes a first sub-coil, and the first sub-coil overlaps with the two hard magnets in the axial direction.

19. The transducer device of claim 17, wherein the at least one first sub-coil includes a plurality of first sub-coils, and a count of the plurality of first sub-coils is unequal to a count of the plurality of hard magnets.

20. The transducer device of claim 17, wherein the magnet assembly includes a plurality of soft magnets, and the plurality of soft magnets and the plurality of hard magnets are disposed in an alternating manner in the axial direction.
